(19) United States
(12) Patent Application Publication
(10) Pub. No.: US 2018/0210865 A1
(43) Pub. Date: Jul. 26, 2018

(54) INFORMATION PROCESSING APPARATUS

(71) Applicant: FUJI XEROX CO., LTD., Tokyo (JP)

(72) Inventors: Qianru QIU, Kanagawa (JP); Yuhei SHIMADA, Kanagawa (JP); Kengo OMURA, Kanagawa (JP)

(73) Assignee: FUJI XEROX CO., LTD., Tokyo (JP)

(21) Appl. No.: 15/692,500

(22) Filed: Aug. 31, 2017

(30) Foreign Application Priority Data
Jan. 24, 2017 (JP) 2017-010307

(51) Int. Cl. G06F 17/21; G06K 9/00; G06F 17/28

(52) U.S. Cl. CPC G06F 17/214; G06F 17/2854; G06K 9/00463; G06F 17/211

(57) ABSTRACT

An information processing apparatus includes a selector that selects at least one typeface with an impression that is most similar to an impression corresponding to a shape feature of a character extracted from a memory that associatively stores shape features of characters and impressions.

### CROSS-REFERENCE TO RELATED APPLICATIONS

This application is based on and claims priority under 35 USC 119 from Japanese Patent Application No. 2017-010307 filed Jan. 24, 2017.

### BACKGROUND

### (i) Technical Field

The present invention relates to an information processing apparatus.

### (ii) Related Art

A person receives different impressions from a character depending on its shape. With a configuration of generating a single font family by grouping multiple existing fonts, it is difficult to select typefaces that have a similar impression.

### SUMMARY

According to an aspect of the invention, there is provided an information processing apparatus including a selector that selects at least one typeface with an impression that is most similar to an impression corresponding to a shape feature of a character extracted from a memory that associatively stores shape features of characters and impressions.

### BRIEF DESCRIPTION OF THE DRAWINGS

An exemplary embodiment of the present invention will be described in detail based on the following figures, wherein:

FIG. 1 is a conceptual module diagram of an exemplary configuration according to an exemplary embodiment;

FIG. 2 is a conceptual module diagram of an exemplary configuration according to the exemplary embodiment;

FIGS. 3A and 3B are diagrams describing an exemplary system configuration using the exemplary embodiment;

FIG. 4 is a diagram illustrating an exemplary data structure of a typeface shape feature kansei table;

FIG. 5 is a diagram illustrating an exemplary data structure of a typeface kansei table;

FIG. 6 is a flowchart illustrating an exemplary process according to the exemplary embodiment;

FIG. 7 is a diagram illustrating an exemplary taste profile used in the exemplary embodiment;

FIG. 8 is a diagram illustrating an exemplary taste profile used in the exemplary embodiment;

FIG. 9 is a diagram illustrating an exemplary specific process (1) according to the exemplary embodiment;

FIG. 10 is a diagram illustrating an exemplary data structure of an analysis result table;

FIG. 11 is a diagram illustrating an exemplary process according to the exemplary embodiment;

FIG. 12 is a diagram illustrating an exemplary data structure of a typeface shape feature kansei table;

FIG. 13 is a diagram illustrating an exemplary data structure of a kansei point table;

FIG. 14 is a diagram illustrating an exemplary data structure of a typeface kansei table;

FIG. 15 is a diagram illustrating an exemplary data structure of an impression distance table;

FIG. 16 is a diagram illustrating an exemplary specific process (2) according to the exemplary embodiment;

FIG. 17 is a diagram illustrating an exemplary data structure of an analysis result table;

FIG. 18 is a diagram illustrating an exemplary process according to the exemplary embodiment;

FIG. 19 is a diagram illustrating an exemplary data structure of a typeface shape feature kansei table;

FIG. 20 is a diagram illustrating an exemplary data structure of a kansei point table;

FIG. 21 is a diagram illustrating an exemplary data structure of a kansei point table;

FIG. 22 is a diagram illustrating an exemplary data structure of a typeface kansei table;

FIG. 23 is a diagram illustrating an exemplary data structure of an impression distance table;

FIG. 24 is a diagram illustrating an exemplary specific process (3) according to the exemplary embodiment;

FIG. 25 is a diagram illustrating an exemplary data structure of an analysis result table;

FIG. 26 is a diagram illustrating an exemplary process according to the exemplary embodiment;

FIG. 27 is a diagram illustrating an exemplary data structure of a typeface shape feature kansei table;

FIG. 28 is a diagram illustrating an exemplary data structure of a kansei point table;

FIG. 29 is a diagram illustrating an exemplary data structure of a typeface kansei table;

FIG. 30 is a diagram illustrating an exemplary data structure of an impression distance table;

FIG. 31 is a diagram illustrating an exemplary process according to the exemplary embodiment;

FIG. 32 is a diagram illustrating an exemplary data structure of a typeface shape feature kansei table;

FIG. 33 is a diagram illustrating an exemplary data structure of a kansei point table;

FIG. 34 is a diagram illustrating an exemplary data structure of a typeface kansei table;

FIG. 35 is a diagram illustrating an exemplary data structure of an impression distance table;

FIG. 36 is a diagram illustrating an exemplary specific process (4) according to the exemplary embodiment;

FIG. 37 is a diagram illustrating an exemplary data structure of an analysis result table;

FIG. 38 is a diagram illustrating an exemplary process according to the exemplary embodiment;

FIG. 39 is a diagram illustrating an exemplary data structure of an analysis result table;

FIG. 40 is a diagram illustrating an exemplary data structure of a typeface shape feature kansei table;

FIG. 41 is a diagram illustrating an exemplary data structure of a typeface shape feature kansei table;

FIG. 42 is a diagram illustrating an exemplary specific process (5) according to the exemplary embodiment;

FIG. 43 is a diagram illustrating an exemplary data structure of an analysis result table; and

FIG. 44 is a block diagram illustrating an exemplary hardware configuration of a computer realizing the exemplary embodiment.

### DETAILED DESCRIPTION

Hereinafter, an exemplary embodiment of the present invention will be described on the basis of the drawings.

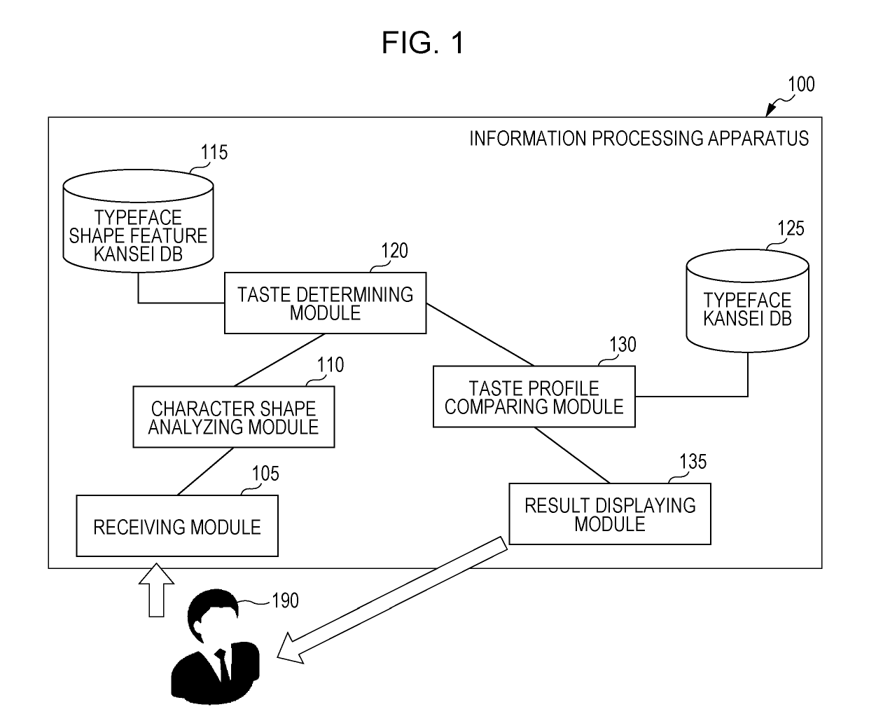

FIG. 1 is a conceptual module diagram of an exemplary configuration according to the exemplary embodiment.

Note that the term “module” refers to components such as software (computer programs) and hardware which are typically capable of being logically separated. Consequently, the term “module” in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, the statement “B is conducted in the case of A” is used to denote that “a determination is made regarding whether or not A holds true, and B is conducted in the case where it is determined that A holds true”. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random-access memory (RAM), an auxiliary or external storage medium, a storage device accessed via a communication link, and a register or the like inside a central processing unit (CPU).

An information processing apparatus 100 according to the exemplary embodiment is configured to generate a second document from a first document. As illustrated in the example in FIG. 1, the information processing apparatus 100 includes a receiving module 105, a character shape analyzing module 110, a typeface shape feature kansei database (DB) 115, a taste determining module 120, a typeface kansei DB 125, a taste profile comparing module 130, and a result displaying module 135.

A second document may be generated to provoke the same impression (which is also referred to as “design taste” or “taste”) as a first document, which is an already-created document. For example, when a first document is a document created in a first language (such as English) and a second document is a document that is a translation of the first document into another language (such as Japanese), the second document may be continuation of the first document. The exemplary embodiment is not limited to such cases and is applicable to any case as long as there is an intention to provoke the same impression from two documents. In particular, such documents include promotional materials (such as advertisements, handbills, pamphlets, posters, catalogs, leaflets, booklets, direct mail (DM), calendars, cards, name cards, web pages, reports, and presentation slides).

In that case, it is necessary to take into consideration an impression of characters, which are elements of a document. This is because an impression of characters also contributes to the overall impression of the document. It is difficult to select a typeface by taking into consideration an impression of characters. For example, this corresponds to the following cases: when there is no electronic document left and a typeface used in a first document that is printed paper is unknown; when a typeface used in a first document is unusable in an environment for creating a second document; and when a typeface corresponding to a typeface used in a first document is unusable in a second document since the two documents are written in languages that use different writing systems, such as in the case of the above-described translation.

As will be described later, impressions are defined by a typeface shape feature kansei table 400 stored in the typeface shape feature kansei DB 115. Exemplary impressions include the following: pretty, casual, dynamic, elegant, classic, dandy, chic, and clear. Whether two documents provoke the same impression is determined by the taste profile comparing module 130 using a distance between each of the values extracted by the taste determining module 120 and each of the values of items of a typeface, as will be described later.

The information processing apparatus 100 evaluates the connection between an original typeface and a selected typeface. In the case of replacing a typeface in a document, a typeface similar to the design taste of the original typeface is selected.

Impressions of characters are configured by multiple items. These “items” configure impressions. Exemplary impressions include the following: pretty, casual, dynamic, elegant, classic, dandy, chic, and clear. Impressions are configured by the values (values representing intensities) of these multiple items.

The receiving module 105 is connected to the character shape analyzing module 110. The receiving module 105 receives a first document in response to an operation performed by a user 190. In this case, the first document may be an already-created document, image, or electronic document. When the first document is an image, receiving the first document includes the following: for example, reading an image with the use of a scanner, a camera, or the like; with the use of a fax machine or the like, receiving an image from an external device through a communication link; and reading an image stored in a hard disk (including a hard disk connected to a computer via a network, besides a built-in hard disk in a computer). An image may be a binary image or a multi-valued image (including a color image). When the first document is an electronic document, the electronic document at least includes text data. The electronic document may include a combination of numeric data, graphic data, image data, moving image data, and audio data. The electronic document is subjected to storage, editing, and retrieval. The electronic document is exchangeable as an individual unit between systems or users, and includes equivalents thereof. The electronic document includes a document and a web page created by a document creating program in accordance with an operation performed by the user 190. The first document to be received may be a single-page document or a multiple-page document. The content of the document may include documents used in business transactions, besides the above-described promotional materials.

Furthermore, the receiving module 105 may receive a second document in response to an operation performed by the user 190. The information processing apparatus 100 changes characters in the second document such that their impressions will be the same as or similar to impressions of characters in the first document. When the second document is a translation of the first document, the receiving module 105 may receive a language into which the translation is to be made.

The character shape analyzing module 110 is connected to the receiving module 105 and the taste determining module 120. The character shape analyzing module 110 analyzes the shape of characters in the first document received by the receiving module 105. In this case, the analysis means extraction of shape features of characters in the first document. Here, the “shape features of characters” include external features of the characters. Exemplary features include the following: whether the characters are serifed (serifs are lines that decorate the start and end points of a character, that is, small extending portions decorated at the start and end points or in other points of a character); whether the characters are lowercase; whether there is the sharp apex (the sharp apex is a triangle where strokes join at the top or bottom of a character); and whether the start and end points of a character have symmetrical shapes (symmetrical or asymmetrical). Note that the apex is a portion corresponding to the vertex of a character.

When the first document is an image, the character shape analyzing module 110 extracts shape features of characters in the image. For example, the character shape analyzing module 110 extracts characters from the image using existing techniques. Then, the character shape analyzing module 110 extracts shape features of the characters. For example, the character shape analyzing module 110 may perform edge detection on each character, convert the edge to a vector, and extract features of the shape. After character recognition is performed, multiple character images of typefaces that have a predetermined shape feature are generated, and the character images are adjusted to the same character size as the characters in the first document. After that, using a pattern matching technique or the like, a difference between the characters in the first document and each of the generated character images is calculated, and, features of a character image of a typeface that has a small difference are regarded as features of the characters in the first document. Whether a character is lowercase is simply determined using character recognition. As a result of the character recognition, a language used in the first document may be identified.

When the first document is an electronic document, the character shape analyzing module 110 extracts shape features of characters in the electronic document. This corresponds to, for example, extracting a typeface in accordance with the properties of the characters in the first document. Once the typeface is identified, the values of items are extractable in accordance with the typeface's features using a typeface kansei table 500. Alternatively, a table that associatively contains typefaces and shape features may be prepared in advance, and shape features may be extracted from the table in accordance with the identified typeface. After that, the same process as that in the case where the first document is an image may be performed. Moreover, a language used in the first document may be identified using text in the first document.

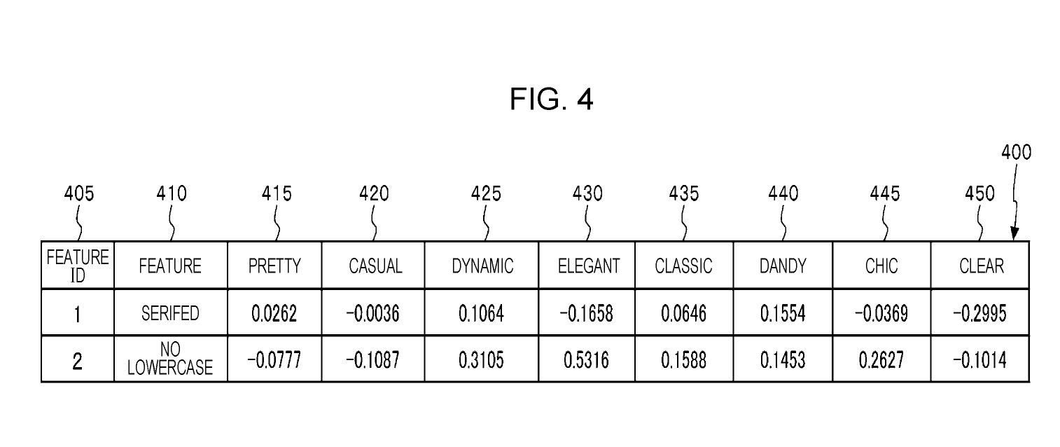

The typeface shape feature kansei DB 115 is connected to the taste determining module 120. The typeface shape feature kansei DB 115 is a database that stores the result of analyzing the intensity of the relationship between a design taste and a shape feature of a particular typeface by performing a kansei evaluation experiment. Specifically, the typeface shape feature kansei DB 115 stores impressions corresponding to each character shape feature. These impressions are configured by the values of items. For example, the typeface shape feature kansei DB 115 stores the typeface shape feature kansei table 400. FIG. 4 is a diagram illustrating an exemplary data structure of the typeface shape feature kansei table 400. The typeface shape feature kansei table 400 includes a feature identification (ID) column 405, a feature column 410, a pretty column 415, a casual column 420, a dynamic column 425, an elegant column 430, a classic column 435, a dandy column 440, a chic column 445, and a clear column 450. The feature ID column 405 stores information (feature ID) for uniquely identifying a feature in the exemplary embodiment. The feature column 410 stores a feature regarding the shape of a character. Exemplary features include “serifed” and “no lowercase”. The pretty column 415 stores the value of “pretty” corresponding to the feature. The casual column 420 stores the value of “casual” corresponding to the feature. The dynamic column 425 stores the value of “dynamic” corresponding to the feature. The elegant column 430 stores the value of “elegant” corresponding to the feature. The classic column 435 stores the value of “classic” corresponding to the feature. The dandy column 440 stores the value of “dandy” corresponding to the feature. The chic column 445 stores the value of “chic” corresponding to the feature. The clear column 450 stores the value of “clear” corresponding to the feature. For example, the first line of the typeface shape feature kansei table 400 indicates that a “serifed” character has high values for impressions such as “dynamic” and “dandy” but has low values for impressions such as “elegant” and “clear”.

The taste determining module 120 is connected to the character shape analyzing module 110, the typeface shape feature kansei DB 115, and the taste profile comparing module 130. The taste determining module 120 extracts the values of items corresponding to a character shape feature extracted by the character shape analyzing module 110. Here, the “values of items” are values indicating the intensity of items such as the above-mentioned “pretty” and so forth.

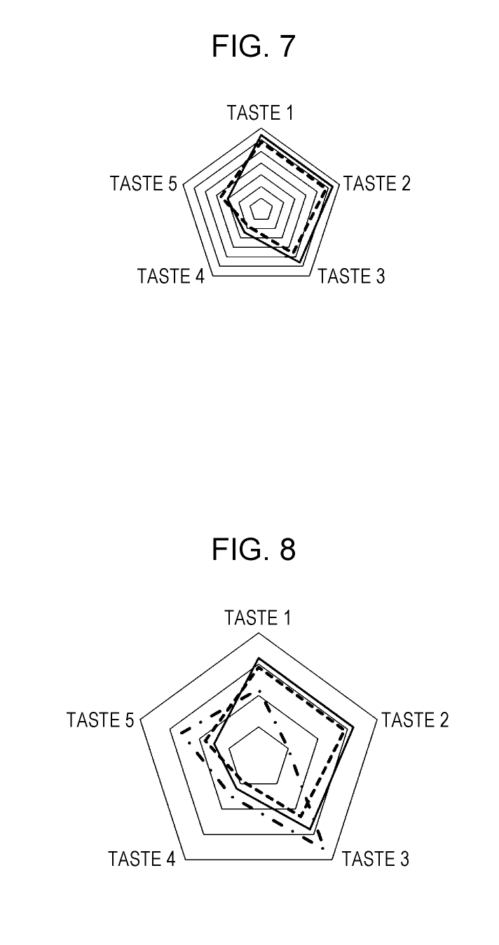

Alternatively, the taste determining module 120 may extract the values of items corresponding to each feature from a table that associatively contains a feature and the values of items of impressions. Specifically, the typeface shape feature kansei table 400 stored in the typeface shape feature kansei DB 115 is used as the “table that associatively contains a feature and the values of items of impressions”. For example, when a character shape feature is “serifed”, the values of the pretty column 415 to the clear column 450 in the typeface shape feature kansei table 400 correspond to the “values of items”. In other words, the taste determining module 120 calculates taste points corresponding to a character shape feature and creates a taste profile. Illustrations of the taste profile will be discussed later using examples illustrated in FIGS. 7 and 8.

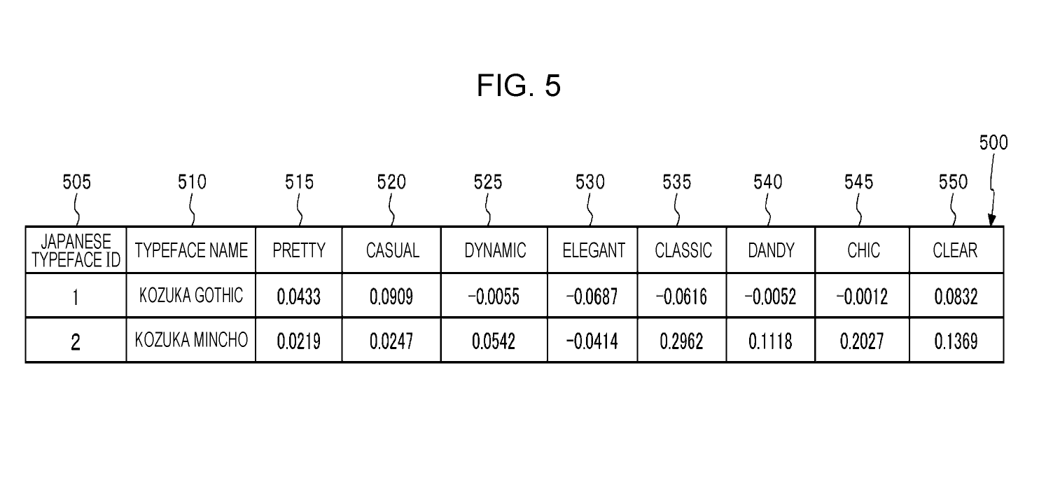

The typeface kansei DB 125 is connected to the taste profile comparing module 130. The typeface kansei DB 125 is a database that stores the result of evaluating the intensity of the relationship between a design taste and a typeface by performing a kansei evaluation experiment. Specifically, the typeface kansei DB 125 stores, in accordance with each typeface, the values of items of impressions received from characters of that typeface. For example, the typeface kansei DB 125 stores the typeface kansei table 500. FIG. 5 is a diagram illustrating an exemplary data structure of the typeface kansei table 500. The typeface kansei table 500 includes a Japanese typeface ID column 505, a typeface name column 510, a pretty column 515, a casual column 520, a dynamic column 525, an elegant column 530, a classic column 535, a dandy column 540, a chic column 545, and a clear column 550. The Japanese typeface ID column 505 stores information (typeface ID) for uniquely identifying a typeface in the exemplary embodiment. The typeface name column 510 stores the name of the typeface. The pretty column 515 stores the value of “pretty” corresponding to the typeface. The casual column 520 stores the value of “casual” corresponding to the typeface. The dynamic column 525 stores the value of “dynamic” corresponding to the typeface. The elegant column 530 stores the value of “elegant” corresponding to the typeface. The classic column 535 stores the value of “classic” corresponding to the typeface. The dandy column 540 stores the value of “dandy” corresponding to the typeface. The chic column 545 stores the value of “chic” corresponding to the typeface. The clear column 550 stores the value of “clear” corresponding to the typeface.

Additionally, the typeface kansei table 500 may be prepared for each element of a document, such as for a heading and body text. This is because the same typeface may provoke different impressions depending on whether the typeface is used in a heading or body text.

The taste profile comparing module 130 is connected to the taste determining module 120, the typeface kansei DB 125, and the result displaying module 135. The taste profile comparing module 130 selects at least one typeface that has impressions that are most similar to impressions extracted in accordance with a character shape feature. Here, being similar includes being identical. For example, the taste profile comparing module 130 compares a taste profile determined by the taste determining module 120 with a taste profile of a typeface to be used in the second document, and extracts a typeface with small impression differences. Specifically, the taste profile comparing module 130 selects a typeface in accordance with a distance between the values extracted by the taste determining module 120 and the values of items of a typeface. Here, the “character shape feature” is a feature extracted by the character shape analyzing module 110. Therefore, the taste profile comparing module 130 selects a typeface using a feature extracted by the character shape analyzing module 110.

The taste profile comparing module 130 may extract characters from the first document. These characters are used by the result displaying module 135 as a target to be translated. The details of this process will be described in detail using an exemplary specific process (3).

When the first document includes characters of different typefaces, the taste profile comparing module 130 may select a typeface to be used in the second document for each of the typefaces in the first document. The details of this process will be described in detail using an exemplary specific process (4).

The result displaying module 135 is connected to the taste profile comparing module 130. The result displaying module 135 presents to the user 190 the result of processing (the result of selecting the typeface) performed by the taste profile comparing module 130.

In addition, the result displaying module 135 may generate a second document using characters of the typeface selected by the taste profile comparing module 130. For example, the result displaying module 135 translates characters (text) in the first document, and generates a second document with the translated text using characters of the typeface selected by the taste profile comparing module 130. Specifically, this corresponds to replacing written content in the first document using a typeface for translation (typeface selected by the taste profile comparing module 130). Then, the result displaying module 135 outputs the second document. Here, outputting the second document includes the following: printing the second document with a printing device such as a printer; displaying the second document on a display device such as a display; transmitting the second document using an image transmitting device such as a fax machine; writing the second document in a storage device such as a document DB; storing the second document in a storage medium such as a memory card; and transferring the second document to another information processing apparatus.

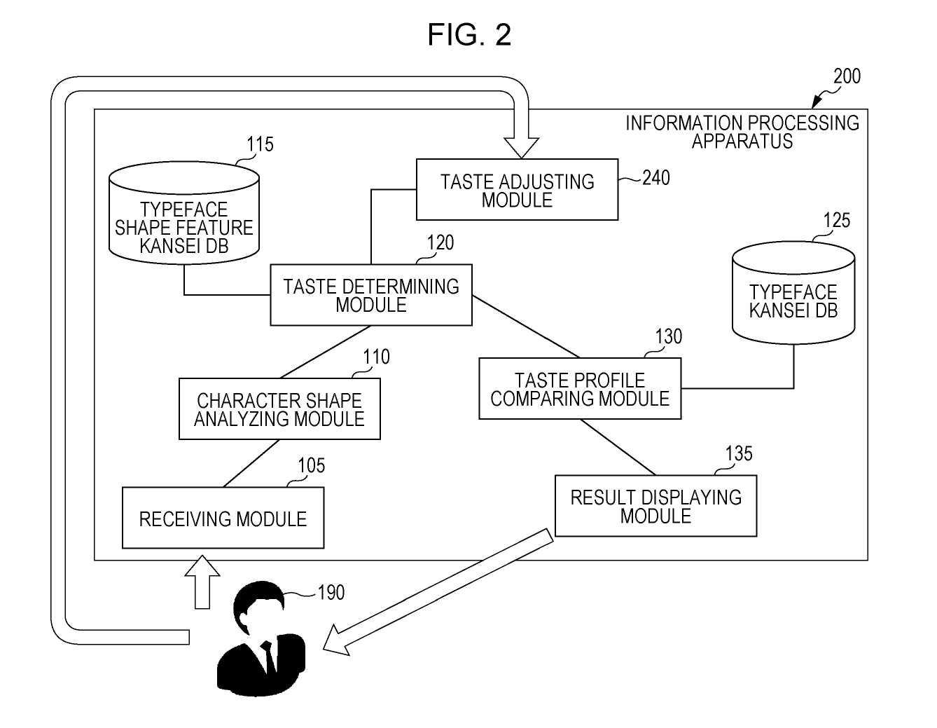

FIG. 2 is a conceptual module diagram of an exemplary configuration (exemplary change) of the present embodiment.

An information processing apparatus 200 includes the receiving module 105, the character shape analyzing module 110, the typeface shape feature kansei DB 115, the taste determining module 120, the typeface kansei DB 125, the taste profile comparing module 130, the result displaying module 135, and a taste adjusting module 240. The information processing apparatus 200 is configured by adding the taste adjusting module 240 to the information processing apparatus 100 illustrated in the example in FIG. 1. The same reference numerals are given to sections that are of the same kind as the information processing apparatus 100 illustrated in the example in FIG. 1, and overlapping descriptions are omitted.

The taste determining module 120 is connected to the character shape analyzing module 110, the typeface shape feature kansei DB 115, the taste profile comparing module 130, and the taste adjusting module 240.

The taste adjusting module 240 is connected to the taste determining module 120. The taste adjusting module 240 adjusts each value extracted by the taste determining module 120, in accordance with an operation performed by the user 190. For example, the taste adjusting module 240 may allow the user 190 to adjust the intensity of each taste on the taste profile determined by the taste determining module 120. Specifically, the taste adjusting module 240 performs adjustment for increasing/decreasing the value of each item on the taste profile, illustrated in the examples in FIGS. 7 and 8.

The taste profile comparing module 130 selects a typeface in accordance with a distance between the values adjusted by the taste adjusting module 240 and the values of items of a typeface. The details of this process will be described later using an exemplary specific process (2).

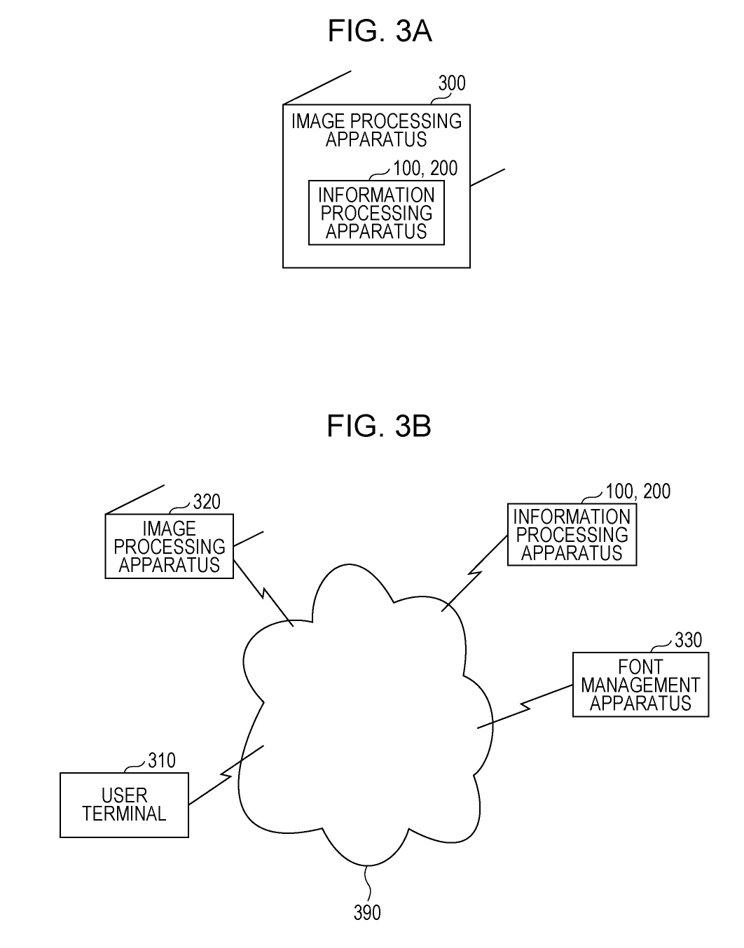

FIGS. 3A and 3B are diagrams illustrating an exemplary system configuration using the exemplary embodiment.

An example illustrated in FIG. 3A is an example in the case where the system is configured as a stand-alone system.

An image processing apparatus 300 includes the information processing apparatus 100 (information processing apparatus 200). The image processing apparatus 300 is a photocopier, a multi-functional peripheral (an image processing apparatus that has two or more functions of a scanner, a printer, a photocopier, a fax machine, and the like), or the like. For example, the scanner of the image processing apparatus 300 reads the first document, and the printer of the image processing apparatus 300 prints the second document, which is the result of processing performed by the information processing apparatus 100.

An example illustrated in FIG. 3B is a system configured by multiple devices connected through a communication link 390. The information processing apparatus 100 (information processing apparatus 200), a user terminal 310, an image processing apparatus 320, and a font management apparatus 330 are connected to one another through the communication link 390. The communication link 390 may be wireless, wired, or a combination thereof. The communication link 390 may be the Internet serving as a communication infrastructure, an intranet, or the like. The functions of the information processing apparatus 100 (information processing apparatus 200) may be realized as cloud services. The font management apparatus 330 is an apparatus that manages fonts, includes, for example, the typeface shape feature kansei DB 115 and the typeface kansei DB 125, and stores font data and the like. The font management apparatus 330 may provide font data in response to a request from the user terminal 310 or the image processing apparatus 320.

For example, when the first document is an image, the first document is read by the scanner of the image processing apparatus 320 and transmitted to the information processing apparatus 100, and the second document, which is the processing result, is printed by the printer of the image processing apparatus 320 or received by the user terminal 310. Alternatively, when the first document is an electronic document, the first document is transmitted from the user terminal 310 to the information processing apparatus 100, and the second document, which is the processing result, is received by the user terminal 310 or printed by the printer of the image processing apparatus 320. In the case of outputting the second document from the user terminal 310 or the image processing apparatus 320 which does not have sufficient font data, the user terminal 310 or the image processing apparatus 320 may download font data from the font management apparatus 330.

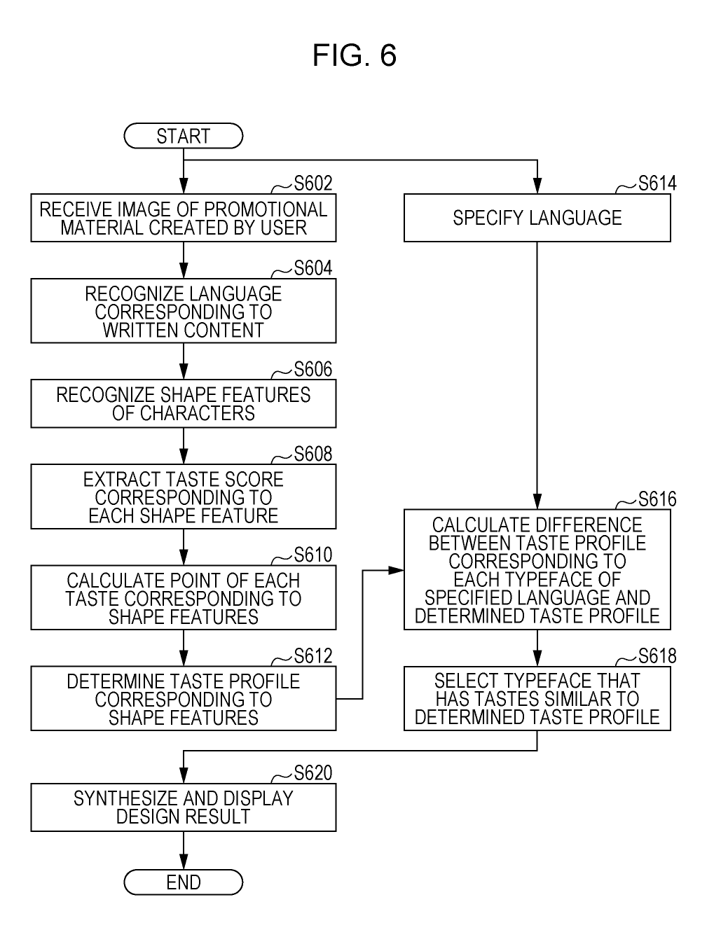

FIG. 6 is a flowchart illustrating an exemplary process according to the exemplary embodiment (performed by the information processing apparatus 100).

In step S602, the receiving module 105 receives an image of a promotional material (first document) created by a user.

In step S604, the character shape analyzing module 110 recognizes the language corresponding to the written content (the language of characters in the first document).

In step S606, the character shape analyzing module 110 recognizes the shape features of the characters.

In step S608, the taste determining module 120 extracts a taste score corresponding to each of the shape features. Specifically, the taste determining module 120 extracts the value of each taste in accordance with each of the shape features using the typeface shape feature kansei table 400.

In step S610, the taste determining module 120 calculates the point of each taste corresponding to the shape features. Specifically, the taste determining module 120 adds the value of each taste corresponding to multiple shape features on a taste by taste basis.

In step S612, the taste determining module 120 generates a taste profile corresponding to the shape features. For example, FIG. 7 illustrates a taste profile including tastes 1 to 5, such as “pretty” and “casual”, serving as five axes. Obviously, a taste profile may be generated with eight tastes on eight axes, as illustrated in the typeface shape feature kansei table 400. In FIG. 7, a solid line represents the typeface of the original language (the language recognized in step S604), and a dotted line represents a specified language (a language to be specified in step S614). Therefore, a taste profile that only includes a solid line is generated at the time of step S612.

In step S614, the receiving module 105 receives a language specified by the user. In other words, the receiving module 105 receives the language of the second document. If the specified language is different from the language recognized in step S604, translation is performed.

In step S616, the taste profile comparing module 130 calculates a difference between a taste profile corresponding to each typeface of the specified language and the determined taste profile. As illustrated in the example in FIG. 7, a difference (distance) between the solid line and the dotted line is calculated. Obviously, the number of typefaces to be compared is plural. For example, FIG. 8 illustrates a taste profile in the case where the number of typefaces to be compared is two. In FIG. 8, a solid line represents the typeface of the original language (the language recognized in step S604), a dotted line represents typeface A of the specified language (the language specified in step S614), and a chain line represents typeface B of the specified language (the language specified in step S614).

Calculations in step S616 are performed using, for example, equations (1):

$${Dist}_{1} = {\sum }_{i = 1}^{m} \sqrt{{( {TasteScore}_{1 , i} - {TasteScore}_{0 , i} )}^{2}} \\ {Dist}_{2} = {\sum }_{i = 1}^{m} \sqrt{{( {TasteScore}_{2 , i} - {TasteScore}_{0 , i} )}^{2}} \\ … \\ {Dist}_{n} = {\sum }_{i = 1}^{m} \sqrt{{( {TasteScore}_{n , i} - {TasteScore}_{0 , i} )}^{2}} \qquad ( 1 )$$

where Dist denotes a distance of taste between two typefaces; m denotes the number of types of tastes; TasteScore denotes the taste score of each typeface; TasteScore_{0,i} denotes the taste score of the typeface of the original language; TasteScore_{1 to n, i} denotes the taste score of each typeface of the specified language; and indices 1 to n denote the individual tastes (items).

In step S618, the taste profile comparing module 130 selects a typeface that has tastes similar to the determined taste profile. Obviously, the taste profile comparing module 130 may select one most similar typeface, or may select multiple typefaces including the most similar typeface, and the user may finally select one of the multiple typefaces. Selecting multiple typefaces includes the following: for example, selecting typefaces whose differences are less than a predetermined threshold; and arranging the typefaces in ascending order of difference, and selecting a predetermined number of typefaces from the top.

In step S620, the result displaying module 135 synthesizes and displays the second document, which is the design result.

Next, a process in the case where the first document is an image will be described using exemplary specific processes (1) to (4), and a process in the case where the first document is an electronic document will be described using an exemplary specific process (5).

### Exemplary Specific Process (1)

This is an example in the case where a promotional material (paper document or flyer) in English is re-created as an electronic document using a Latin typeface stored in the typeface kansei DB 125. In other words, this is the case where the first document is a Latin-script document, and the second document is also a Latin-script document.

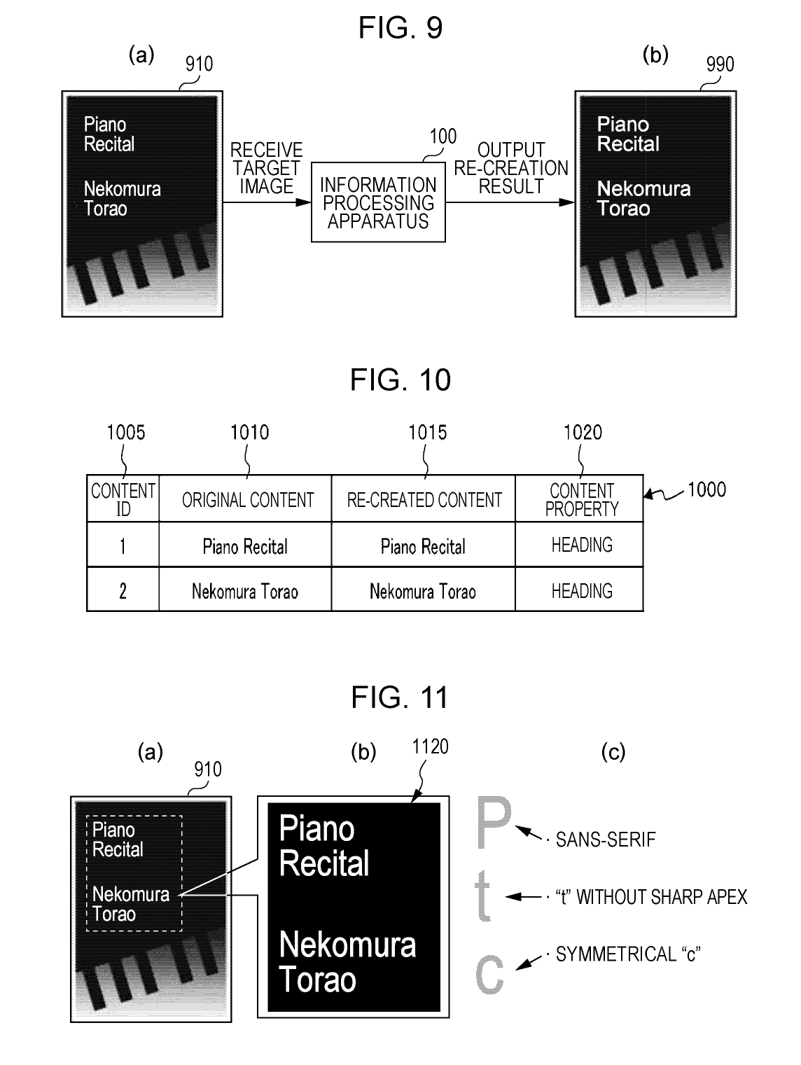

FIG. 9 is a diagram illustrating the exemplary specific process (1) according to the exemplary embodiment. An example will be described in which the information processing apparatus 100 receives a target image 910 as a target image and outputs a processing result image 990 as the re-creation result. Specifically, a flyer in English is scanned, the scanned image is input to the information processing apparatus 100, and a flyer in English with the identical tastes is re-created.

The character shape analyzing module 110 has the function as a character and character-typeface-feature recognition engine, and recognizes that the written content of (the language used in) the target image 910 is English. The character shape analyzing module 110 extracts the shape of characters in the target image 910. Thereafter, the taste determining module 120 searches the typeface shape feature kansei DB 115 containing Latin typefaces for that shape to obtain taste points, and calculates a taste profile of the characters. The taste profile comparing module 130 has the function as a typeface selecting engine, and picks up (extracts) a Latin typeface that has tastes similar to the taste profile of the characters, calculated by the taste determining module 120.

An analysis result table 1000 is generated as the processing result of character recognition performed by the character shape analyzing module 110. FIG. 10 is a diagram illustrating an exemplary data structure of the analysis result table 1000. The analysis result table 1000 includes a content ID column 1005, an original content column 1010, a re-created content column 1015, and a content property column 1020. The content ID column 1005 stores information (content ID) for uniquely identifying content in the exemplary embodiment. The original content column 1010 stores original content. In other words, the original content column 1010 stores the result of character recognition. The re-created content column 1015 stores re-created content. In this example, the re-created content is the same as the content in the original content column 1010. The content in the re-created content column 1015 is determined in accordance with an instruction given from the user 190. In this case, an instruction is given to reproduce the target image 910 as it is. The content property column 1020 stores a content property indicating the type of elements of the document. The character shape analyzing module 110 recognizes elements of the document using existing techniques. For example, each element is classified as a heading, body text, or the like by comparing the size of characters with a predetermined threshold. In accordance with each of the elements, target typefaces (typefaces in the typeface kansei DB 125) may be limited. For example, all typefaces may serve as targets for a heading, but only “Mincho-tai” (Ming typefaces) and “Gothic-tai” (East Asian gothic typefaces) may serve as targets for body text.

FIG. 11 is a diagram illustrating an exemplary process according to the exemplary embodiment. This indicates an exemplary character shape analyzing process performed by the character shape analyzing module 110.

The character shape analyzing module 110 extracts a heading area 1120 from the target image 910 (see parts (a) and (b) of FIG. 11). The character shape analyzing module 110 extracts a shape feature of each of the characters. For example, as illustrated in the example in part (c) of FIG. 11, “sans-serif” is extracted from the character “P”; “without sharp apex” is extracted from the character “t”; and “symmetrical” is extracted from the character “c”.

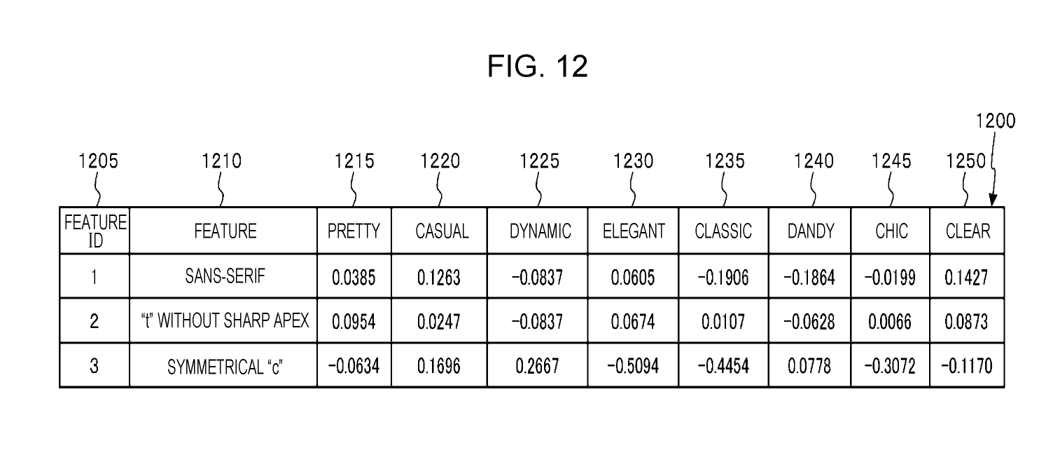

The taste determining module 120 extracts, from the typeface shape feature kansei DB 115, taste points regarding each of the shape features extracted by the character shape analyzing module 110. For example, the taste determining module 120 generates a typeface shape feature kansei table 1200 as the extraction result. FIG. 12 is a diagram illustrating an exemplary data structure of the typeface shape feature kansei table 1200. The typeface shape feature kansei table 1200 includes a feature ID column 1205, a feature column 1210, a pretty column 1215, a casual column 1220, a dynamic column 1225, an elegant column 1230, a classic column 1235, a dandy column 1240, a chic column 1245, and a clear column 1250. The feature ID column 1205 stores information (feature ID) for uniquely identifying a feature in the exemplary embodiment. The feature column 1210 stores the feature. The pretty column 1215 stores the value of “pretty”. The casual column 1220 stores the value of “casual”. The dynamic column 1225 stores the value of “dynamic”. The elegant column 1230 stores the value of “elegant”. The classic column 1235 stores the value of “classic”. The dandy column 1240 stores the value of “dandy”. The chic column 1245 stores the value of “chic”. The clear column 1250 stores the value of “clear”. In the example illustrated in FIG. 12, the values of eight items (kansei score) are extracted for each of the three features ((1) sans-serif, (2) “t” without sharp apex, and (3) symmetrical “c”).

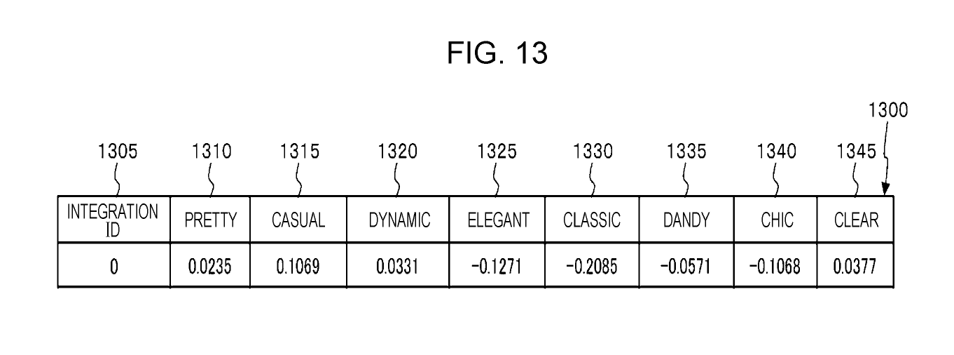

The taste determining module 120 generates a kansei point table 1300 from the typeface shape feature kansei table 1200. FIG. 13 is a diagram illustrating an exemplary data structure of the kansei point table 1300. The kansei point table 1300 includes an integration ID column 1305, a pretty column 1310, a casual column 1315, a dynamic column 1320, an elegant column 1325, a classic column 1330, a dandy column 1335, a chic column 1340, and a clear column 1345. The integration ID column 1305 stores information (integration ID) for uniquely identifying integration of the values of each item in the exemplary embodiment. The pretty column 1310 stores the integrated value of “pretty”. The casual column 1315 stores the integrated value of “casual”. The dynamic column 1320 stores the integrated value of “dynamic”. The elegant column 1325 stores the integrated value of “elegant”. The classic column 1330 stores the integrated value of “classic”. The dandy column 1335 stores the integrated value of “dandy”. The chic column 1340 stores the integrated value of “chic”. The clear column 1345 stores the integrated value of “clear”.

Specifically, the kansei point of the written content of the target image 910 is calculated using the kansei scores of the extracted features. The kansei point of “pretty” (first item) is calculated using equation (2), and the calculated result is the so-called average:

$${ScoreOfCharacter}_{pretty} = \frac{{\sum }_{i = 1}^{n} {ScoreOfCharacter}_{i , pretty}}{CountOfCharacters} \qquad ( 2 )$$

where ScoreOfCharacter_{pretty} denotes the kansei point of “pretty”, which is the value in the pretty column 1310; ScoreOfCharacter_{i, pretty} denotes the kansei point of “pretty” of each feature, which is the value in the pretty column 1215; and CountOfCharacters denotes the number of extracted features, which is the number of items (three) in the feature ID column 1205. In the example illustrated in FIG. 12, “(0.0385+0.0954-0.0634)/3” is calculated to obtain “0.0235” illustrated in the example in FIG. 13. Obviously, an equivalent equation may be simply used for the other items (such as “casual”).

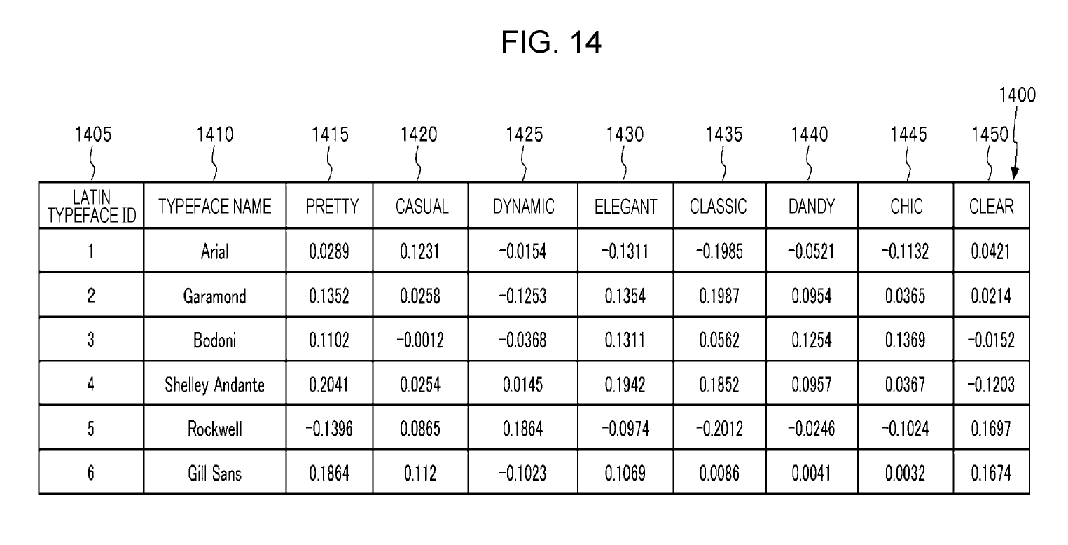

Next, the taste profile comparing module 130 extracts one or more typefaces that are Latin typefaces and that are usable for headings from the typeface kansei DB 125. For example, the taste profile comparing module 130 generates a typeface kansei table 1400 as the extraction result. FIG. 14 is a diagram illustrating an exemplary data structure of the typeface kansei table 1400. The typeface kansei table 1400 includes a Latin typeface ID column 1405, a typeface name column 1410, a pretty column 1415, a casual column 1420, a dynamic column 1425, an elegant column 1430, a classic column 1435, a dandy column 1440, a chic column 1445, and a clear column 1450. The Latin typeface ID column 1405 stores information (Latin typeface ID) for uniquely identifying a Latin typeface in the exemplary embodiment. The typeface name column 1410 stores the name of the typeface. The pretty column 1415 stores the value of “pretty” corresponding to the typeface. The casual column 1420 stores the value of “casual” corresponding to the typeface. The dynamic column 1425 stores the value of “dynamic” corresponding to the typeface. The elegant column 1430 stores the value of “elegant” corresponding to the typeface. The classic column 1435 stores the value of “classic” corresponding to the typeface. The dandy column 1440 stores the value of “dandy” corresponding to the typeface. The chic column 1445 stores the value of “chic” corresponding to the typeface. The clear column 1450 stores the value of “clear” corresponding to the typeface.

These are the result of extracting, from the typeface kansei DB 125, six typefaces for headings as taste points (kansei score) regarding each Latin typeface.

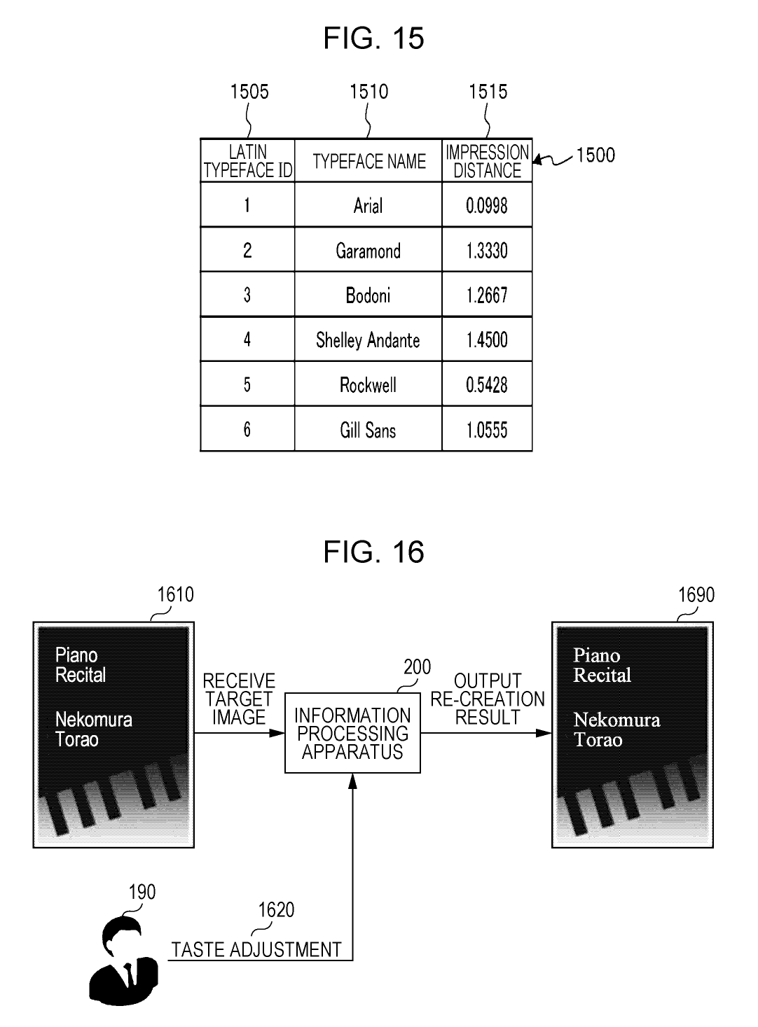

The taste profile comparing module 130 generates an impression distance table 1500 from the kansei point table 1300 and the typeface kansei table 1400. FIG. 15 is a diagram illustrating an exemplary data structure of the impression distance table 1500. The impression distance table 1500 includes a Latin typeface ID column 1505, a typeface name column 1510, and an impression distance column 1515. The Latin typeface ID column 1505 stores a Latin typeface ID. The typeface name column 1510 stores the name of the typeface. The impression distance column 1515 stores an impression distance.

Specifically, an impression distance from the integrated kansei points is calculated using the kansei score of each typeface, and, for example, a typeface with the smallest distance (or multiple typefaces including a typeface with the smallest distance) is selected. In this example, the typeface “Arial” is selected. The result displaying module 135 generates and presents a processing result image 990 using characters of the typeface “Arial” (the re-created content column 1015 in the analysis result table 1000). Obviously, multiple typefaces may be selected, as described above. When multiple typefaces are selected, multiple processing result images 990 may be created using the individual typefaces, and may be presented to the user 190 to select one from the processing result images 990.

Specifically, an impression distance of each typeface is calculated using equation (3):

$${Dist}_{n} = {\sum }_{i = 1}^{m} \sqrt{{( {TasteScore}_{n , i} - {TasteScore}_{0 , i} )}^{2}} \qquad ( 3 )$$

where Dist denotes the impression distance of typeface n, which is the value in the impression distance column 1515; TasteScore_{n, i} is the kansei score of each taste of typeface n, which is, in the case of “pretty”, the value in the pretty column 1415; and TasteScore_{0, i} is the kansei point of each taste in the kansei point table 1300.

### Exemplary Specific Process (2)

This is an example in the case where the taste of a promotional material (paper document or flyer) in English is adjusted in accordance with an operation performed by the user 190, and is re-created as an electronic document using a Latin typeface stored in the typeface kansei DB 125. In other words, this is the case where the first document is a Latin-script document and the second document is also a Latin-script document, and values extracted by the taste determining module 120 are adjusted in accordance with a user operation. Note that descriptions of processing equivalent to that in the exemplary specific process (1), such as calculations using equations (2) and (3), are omitted.

FIG. 16 is a diagram illustrating the exemplary specific process (2) according to the exemplary embodiment. An example will be described in which the information processing apparatus 200 receives a target image 1610 as a target image, the user 190 performs taste adjustment 1620, and, after the adjustment, the information processing apparatus 200 outputs a processing result image 1690 as the re-creation result. Specifically, a flyer in English is scanned, the scanned image is input to the information processing apparatus 200, the tastes thereof are adjusted, and a flyer in English with the identical tastes is re-created.

The following description assumes that, for the taste adjustment 1620, for example, an adjustment instruction to intensify the “elegant” taste and the “classic” taste has been given. Note that processing other than that performed by the taste adjusting module 240 is equivalent to that in the exemplary specific process (1).

The character shape analyzing module 110 has the function as a character and character-typeface-feature recognition engine, and recognizes that the written content of (the language used in) the target image 1610 is English. The character shape analyzing module 110 extracts the shape of each character in the target image 1610. Thereafter, the taste determining module 120 searches the typeface shape feature kansei DB 115 containing Latin typefaces for that shape to obtain taste points, and calculates a taste profile of the characters. The taste adjusting module 240 adjusts the tastes in accordance with the taste adjustment 1620 performed by the user 190. The taste profile comparing module 130 has the function as a typeface selecting engine, and picks up (extracts) a Latin typeface that has tastes similar to the taste profile of the characters, adjusted by the taste adjusting module 240.

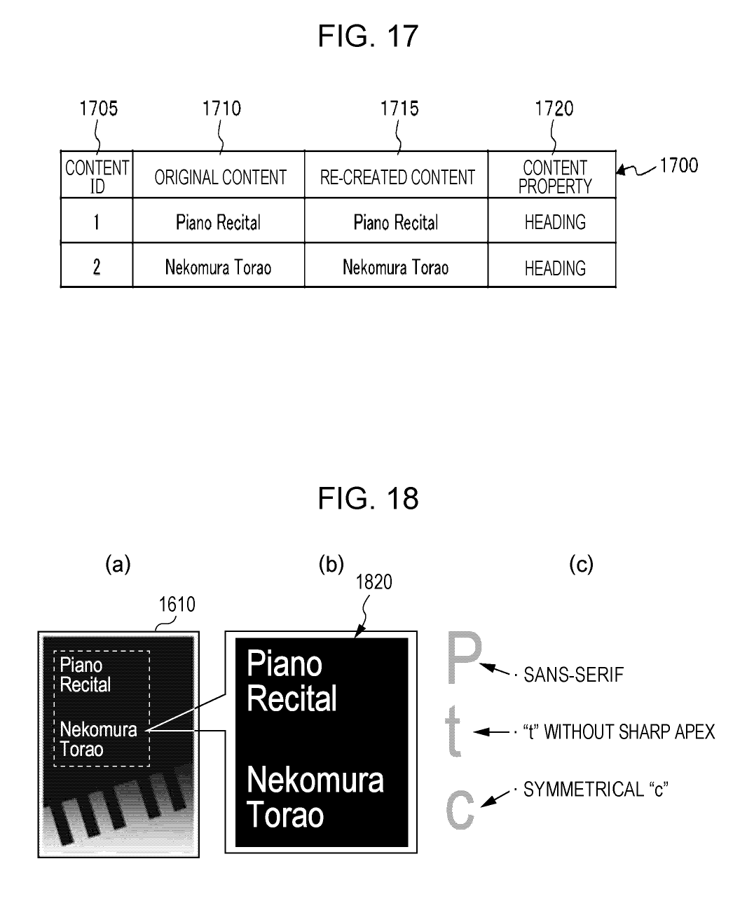

An analysis result table 1700 is generated as the processing result of character recognition performed by the character shape analyzing module 110. FIG. 17 is a diagram illustrating an exemplary data structure of the analysis result table 1700. The analysis result table 1700 includes a content ID column 1705, an original content column 1710, a re-created content column 1715, and a content property column 1720. This is equivalent to the data structure of the analysis result table 1000 illustrated in the example in FIG. 10 in the exemplary specific process (1).

FIG. 18 is a diagram illustrating an exemplary process according to the exemplary embodiment. This indicates an exemplary character shape analyzing process performed by the character shape analyzing module 110. This is equivalent to the example illustrated in FIG. 11 in the exemplary specific process (1).

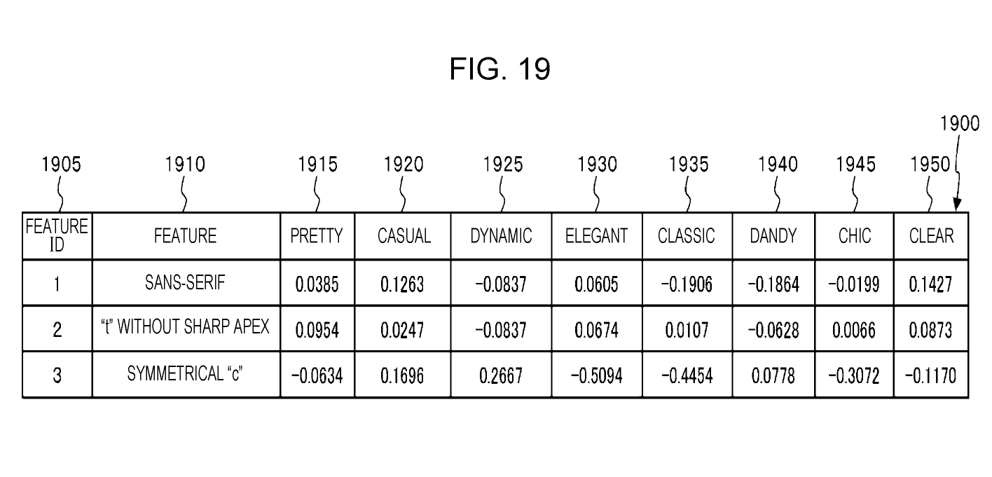

The taste determining module 120 extracts, from the typeface shape feature kansei DB 115, taste points regarding each of the shape features extracted by the character shape analyzing module 110. For example, the taste determining module 120 generates a typeface shape feature kansei table 1900 as the extraction result. FIG. 19 is a diagram illustrating an exemplary data structure of the typeface shape feature kansei table 1900. The typeface shape feature kansei table 1900 includes a feature ID column 1905, a feature column 1910, a pretty column 1915, a casual column 1920, a dynamic column 1925, an elegant column 1930, a classic column 1935, a dandy column 1940, a chic column 1945, and a clear column 1950. This is equivalent to the data structure in the example illustrated in FIG. 12 in the exemplary specific process (1).

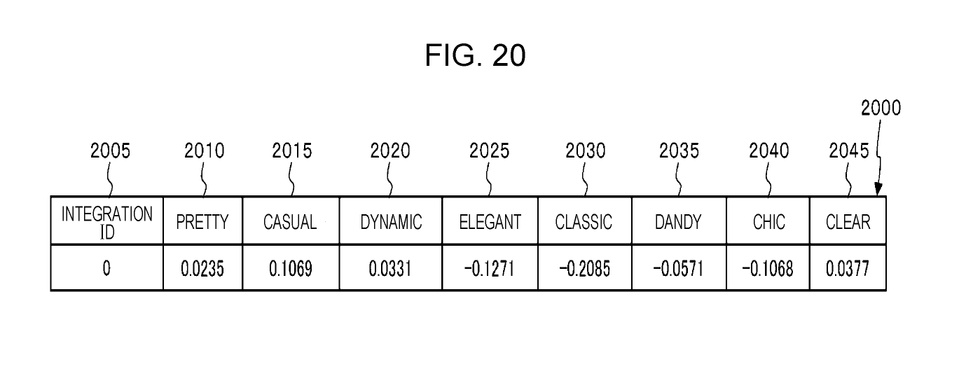

The taste determining module 120 generates a kansei point table 2000 from the typeface shape feature kansei table 1900. FIG. 20 is a diagram illustrating an exemplary data structure of the kansei point table 2000. The kansei point table 2000 includes an integration ID column 2005, a pretty column 2010, a casual column 2015, a dynamic column 2020, an elegant column 2025, a classic column 2030, a dandy column 2035, a chic column 2040, and a clear column 2045. This is equivalent to the data structure in the example illustrated in FIG. 13 in the exemplary specific process (1).

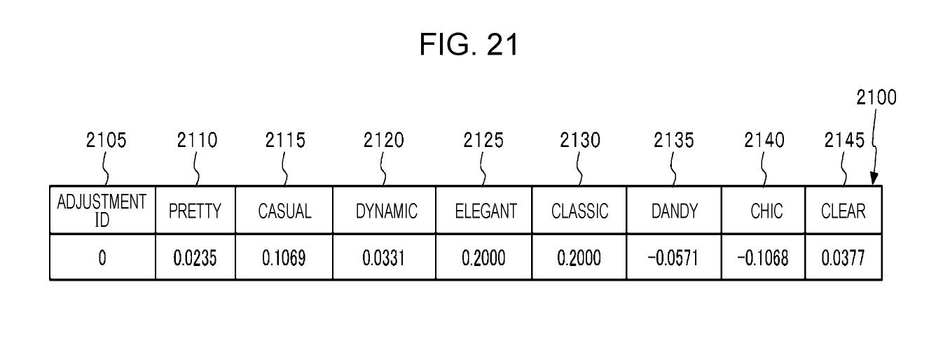

Next, the taste adjusting module 240 generates a kansei point table 2100, having the value of “elegant” as “+0.3271” and the value of “classic” as “+0.4085” in the kansei point table 2000, in accordance with an instruction for the taste adjustment 1620 given by the user 190. FIG. 21 is a diagram illustrating an exemplary data structure of the kansei point table 2100. The kansei point table 2100 includes an adjustment ID column 2105, a pretty column 2110, a casual column 2115, a dynamic column 2120, an elegant column 2125, a classic column 2130, a dandy column 2135, a chic column 2140, and a clear column 2145. This is equivalent to that of the kansei point table 2000 illustrated in the example in FIG. 20. However, the value in the elegant column 2125 is changed from “−0.1271” to “0.2000”, and the value in the classic column 2130 is changed from “−0.2085” to “0.2000”.

For example, as an instruction for the taste adjustment 1620 given by the user 190, a taste profile such as that indicated in the examples illustrated in FIGS. 7 and 8 is presented, and an operation to intensify the values on the elegant and classic axes is performed.

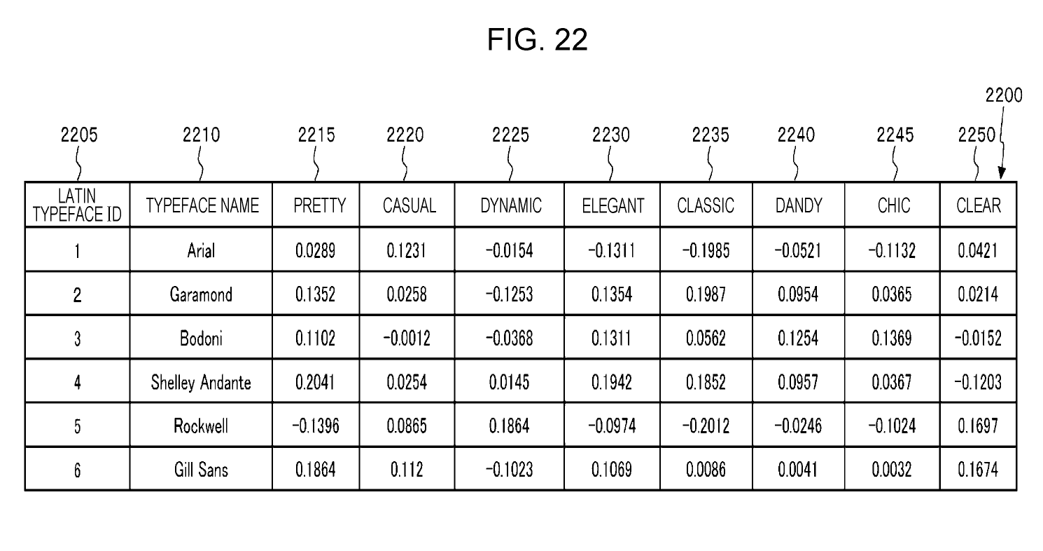

Next, the taste profile comparing module 130 extracts one or more typefaces that are Latin typefaces and that are usable for headings from the typeface kansei DB 125. For example, the taste profile comparing module 130 generates a typeface kansei table 2200 as the extraction result. FIG. 22 is a diagram illustrating an exemplary data structure of the typeface kansei table 2200. The typeface kansei table 2200 includes a Latin typeface ID column 2205, a typeface name column 2210, a pretty column 2215, a casual column 2220, a dynamic column 2225, an elegant column 2230, a classic column 2235, a dandy column 2240, a chic column 2245, and a clear column 2250. This is equivalent to the data structure in the example illustrated in FIG. 14 in the exemplary specific process (1).

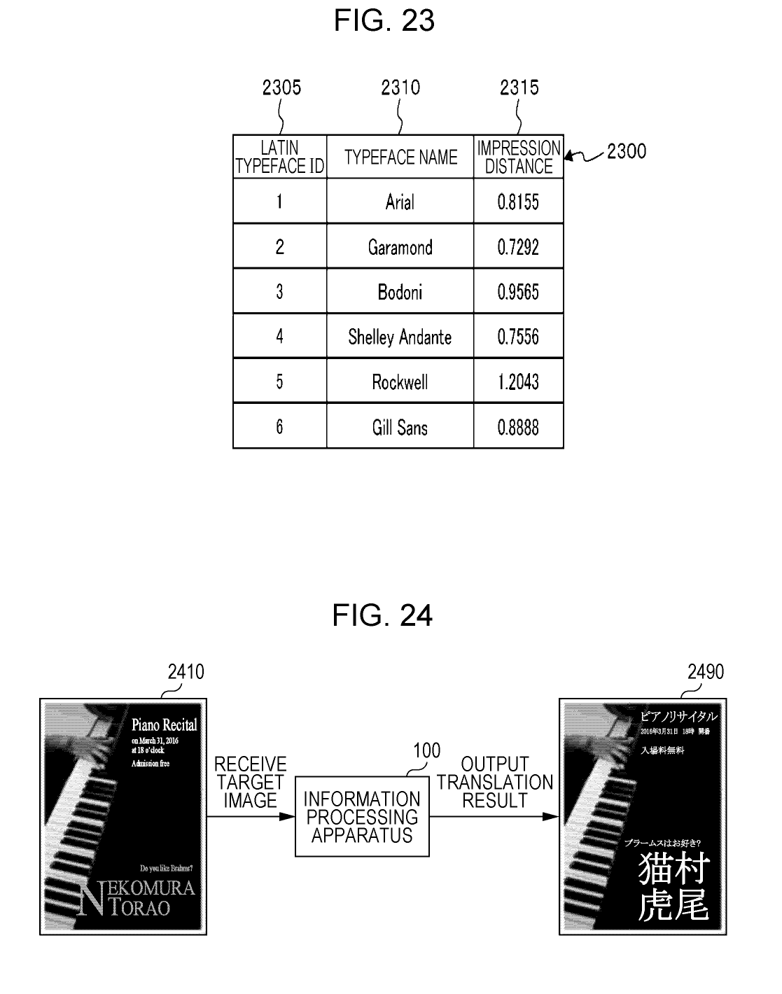

The taste profile comparing module 130 generates an impression distance table 2300 from the kansei point table 2100 and the typeface kansei table 2200. FIG. 23 is a diagram illustrating an exemplary data structure of the impression distance table 2300. The impression distance table 2300 includes a Latin typeface ID column 2305, a typeface name column 2310, and an impression distance column 2315. This is equivalent to the data structure in the example illustrated in FIG. 15 in the exemplary specific process (1).

Specifically, an impression distance from the integrated kansei points is calculated using the kansei score of each typeface, and, for example, a typeface with the smallest distance (or multiple typefaces including a typeface with the smallest distance) is selected. In this example, the typeface “Garamond” is selected. The result displaying module 135 generates and presents a processing result image 1690 using characters of the typeface “Garamond” (the re-created content column 1715 in the analysis result table 1700). Obviously, multiple typefaces may be selected, as described above. When multiple typefaces are selected, multiple processing result images 1690 may be created using the individual typefaces, and may be presented to the user 190 to select one from the processing result images 1690.

### Exemplary Specific Process (3)

This is an example in the case where a promotional material (paper document or flyer) in English is translated into Japanese, and is re-created as an electronic document using a Japanese typeface stored in the typeface kansei DB 125. In other words, this is the case where the first document is a Latin-script document, and the second document is a Japanese document. Note that there are body text and a heading, and separate processing is performed such that their tastes become identical.

FIG. 24 is a diagram illustrating the exemplary specific process (3) according to the exemplary embodiment. An example will be described in which the information processing apparatus 100 receives a target image 2410 as a target image, and, after the translation, outputs a processing result image 2490 as the re-creation result. Specifically, a flyer in English is scanned, the scanned image is input to the information processing apparatus 100, and a flyer in Japanese with the identical tastes is re-created.

The character shape analyzing module 110 has the function as a character and character-typeface-feature recognition engine and the function as a translation engine, recognizes that the written content of (the language used in) the target image 2410 is English, recognizes the characters, and translates the content from English to Japanese. The character shape analyzing module 110 extracts the shape of each character in the target image 2410. Thereafter, the taste determining module 120 searches the typeface shape feature kansei DB 115 containing Latin typefaces for that shape to obtain taste points, and calculates a taste profile of the characters. The taste profile comparing module 130 has the function as a typeface selecting engine, and picks up (extracts) a Japanese typeface that has tastes similar to the taste profile of the characters, calculated by the taste determining module 120.

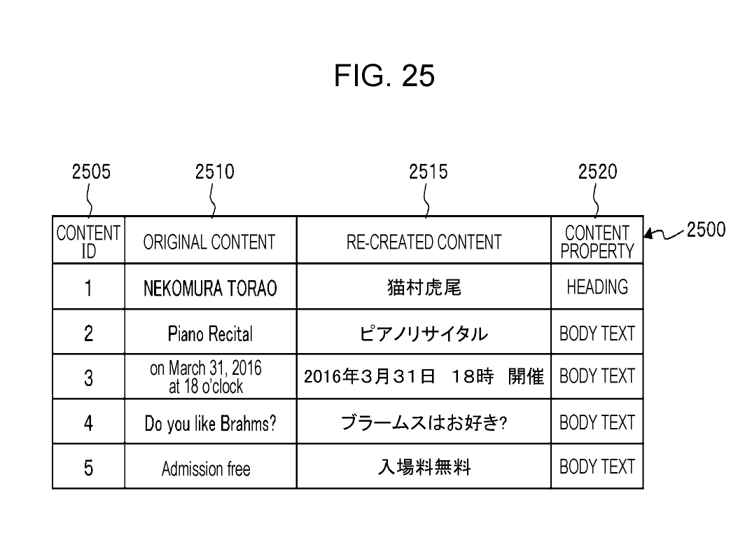

An analysis result table 2500 is generated as the processing result of character recognition and translation performed by the character shape analyzing module 110. FIG. 25 is a diagram illustrating an exemplary data structure of the analysis result table 2500. The analysis result table 2500 includes a content ID column 2505, an original content column 2510, a re-created content column 2515, and a content property column 2520. This is equivalent to the data structure of the analysis result table 1000 illustrated in the example in FIG. 10 in the exemplary specific process (1). However, the details in the re-created content column 2515 are in Japanese corresponding to the original content column 2510. FIG. 25 illustrates an example in which the content is classified into a heading and body text. Different typefaces (typefaces in the typeface kansei DB 125) are applied to the heading and body text. In the example, all typefaces may serve as targets for a heading, but only “Mincho-tai” (Ming typefaces) and “Gothic-tai” (East Asian gothic typefaces) may serve as targets for body text.

Hereinafter, separate processing is performed for the body text portions and the heading portion.

Firstly, the following processing is performed for the heading portion. Obviously, either of the heading portion and the text portions may be processed first, or both may be processed in parallel.

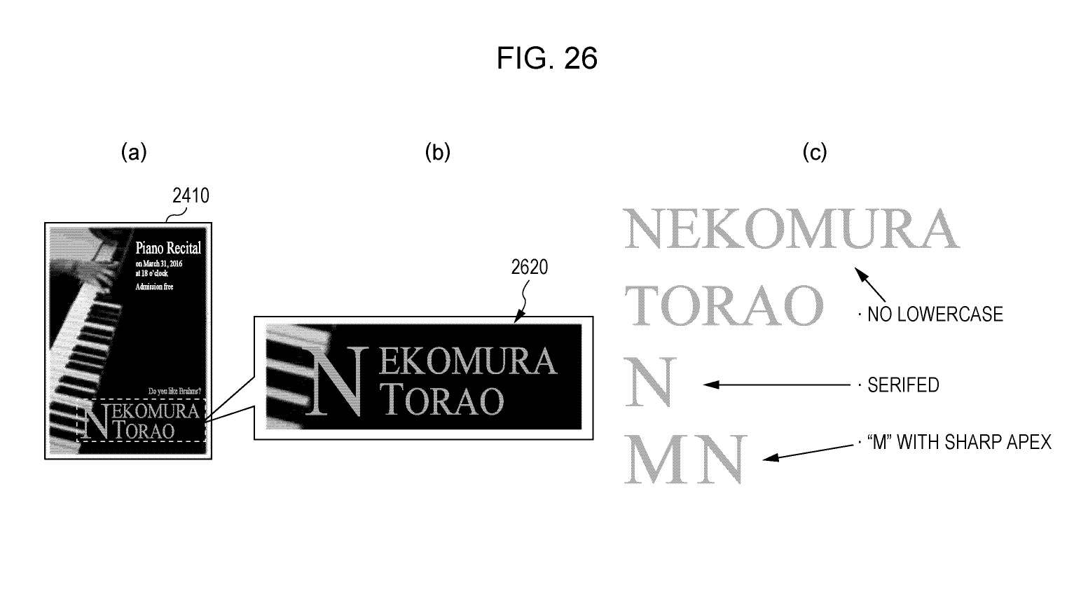

FIG. 26 is a diagram illustrating an exemplary process according to the exemplary embodiment. This indicates an exemplary character shape analyzing process performed by the character shape analyzing module 110.

The character shape analyzing module 110 extracts a heading area 2620 from the target image 2410 (see parts (a) and (b) of FIG. 26). The character shape analyzing module 110 extracts a shape feature of each of the characters. For example, as illustrated in the example in part (c) of FIG. 26, “no lowercase” is extracted from the characters “NEKOMURA TORAO”; “serifed” is extracted from the character “N”; and “‘M’ with sharp apex” is extracted from the characters “MN”.

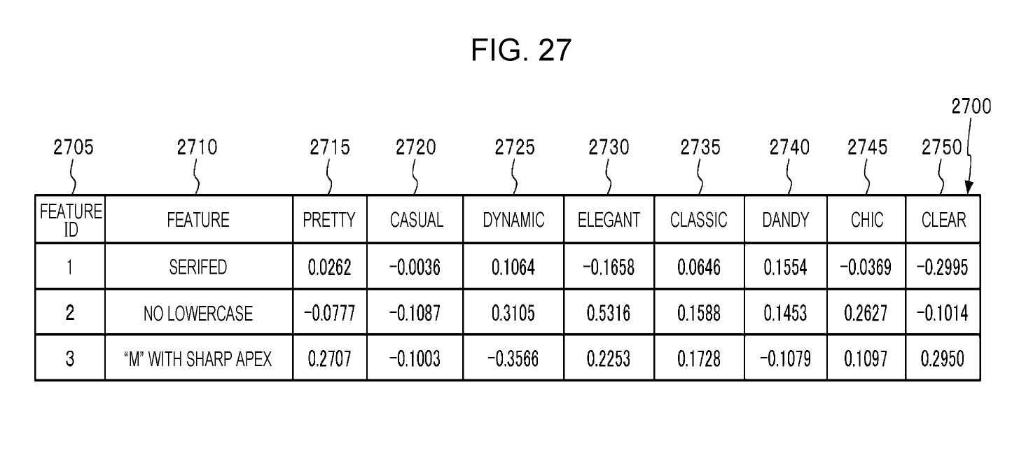

The taste determining module 120 extracts, from the typeface shape feature kansei DB 115, taste points regarding each of the shape features extracted by the character shape analyzing module 110. For example, the taste determining module 120 generates a typeface shape feature kansei table 2700 as the extraction result. FIG. 27 is a diagram illustrating an exemplary data structure of the typeface shape feature kansei table 2700. The typeface shape feature kansei table 2700 includes a feature ID column 2705, a feature column 2710, a pretty column 2715, a casual column 2720, a dynamic column 2725, an elegant column 2730, a classic column 2735, a dandy column 2740, a chic column 2745, and a clear column 2750. This is equivalent to the data structure in the example illustrated in FIG. 12 in the exemplary specific process (1).

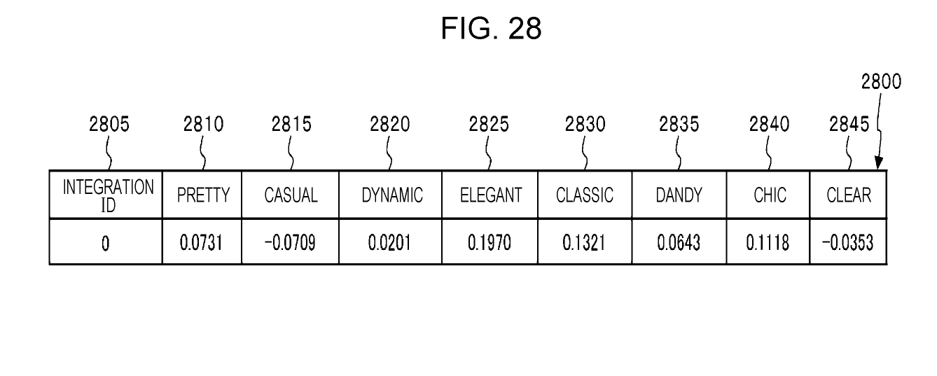

The taste determining module 120 generates a kansei point table 2800 from the typeface shape feature kansei table 2700. FIG. 28 is a diagram illustrating an exemplary data structure of the kansei point table 2800. The kansei point table 2800 includes an integration ID column 2805, a pretty column 2810, a casual column 2815, a dynamic column 2820, an elegant column 2825, a classic column 2830, a dandy column 2835, a chic column 2840, and a clear column 2845. This is equivalent to the data structure in the example illustrated in FIG. 13 in the exemplary specific process (1).

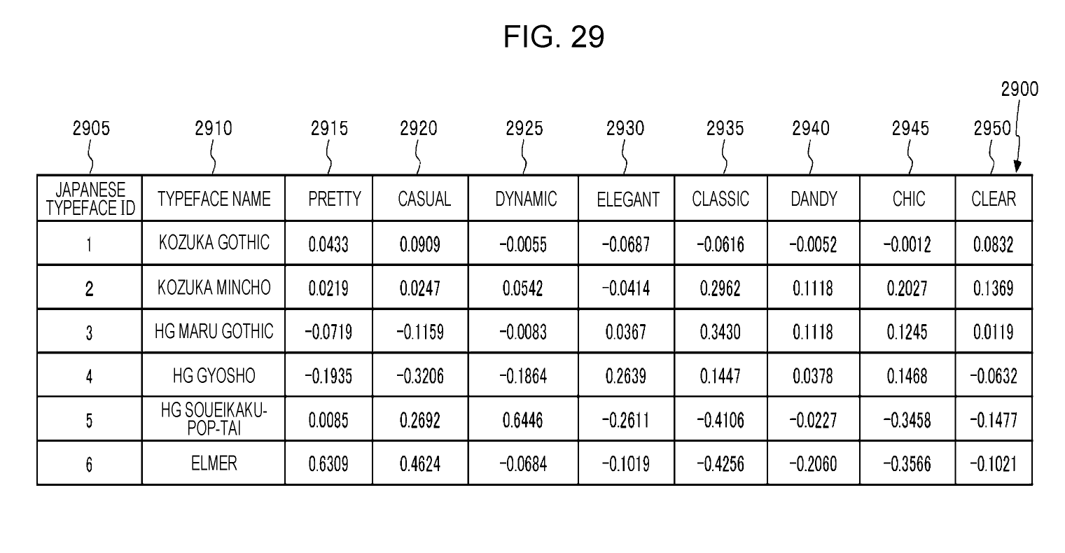

Next, the taste profile comparing module 130 extracts one or more typefaces that are Japanese typefaces and that are usable for the heading from the typeface kansei DB 125. For example, the taste profile comparing module 130 generates a typeface kansei table 2900 as the extraction result. FIG. 29 is a diagram illustrating an exemplary data structure of the typeface kansei table 2900. The typeface kansei table 2900 includes a Japanese typeface ID column 2905, a typeface name column 2910, a pretty column 2915, a casual column 2920, a dynamic column 2925, an elegant column 2930, a classic column 2935, a dandy column 2940, a chic column 2945, and a clear column 2950. This is equivalent to the data structure in the example illustrated in FIG. 14 in the exemplary specific process (1). This is the example where there are six Japanese typefaces for the heading.

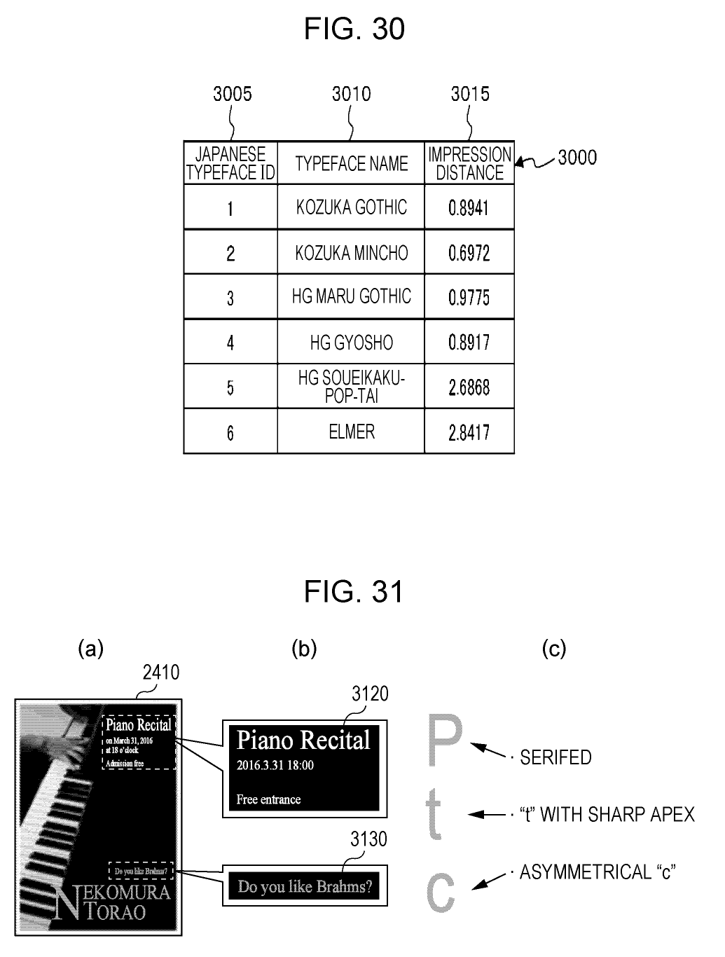

The taste profile comparing module 130 generates an impression distance table 3000 from the kansei point table 2800 and the typeface kansei table 2900. FIG. 30 is a diagram illustrating an exemplary data structure of the impression distance table 3000. The impression distance table 3000 includes a Japanese typeface ID column 3005, a typeface name column 3010, and an impression distance column 3015. This is equivalent to the data structure in the example illustrated in FIG. 15 in the exemplary specific process (1).

Specifically, an impression distance from the integrated kansei points is calculated using the kansei score of each typeface, and, for example, a typeface with the smallest distance (or multiple typefaces including a typeface with the smallest distance) is selected. In this example, the typeface “Kozuka Mincho” is selected. The result displaying module 135 creates a processing result image 2490 using characters of the typeface “Kozuka Mincho” (the heading portion in the re-created content column 2515 in the analysis result table 2500). Obviously, multiple typefaces may be selected, as described above. When multiple typefaces are selected, the heading portion in multiple processing result images 2490 may be created using the individual typefaces.

Next, processing equivalent to that for the heading portion is performed for the body text portions.

FIG. 31 is a diagram illustrating an exemplary process according to the exemplary embodiment. This indicates an exemplary character shape analyzing process performed by the character shape analyzing module 110.

The character shape analyzing module 110 extracts a body text area 3120 and a body text area 3130 from the target image 2410 (see parts (a) and (b) of FIG. 31). The character shape analyzing module 110 extracts a shape feature of each of the characters. For example, as illustrated in the example in part (c) of FIG. 31, “serifed” is extracted from the character “P”; “‘t’ with sharp apex” is extracted from the character “t”; and “asymmetrical ‘c’” is extracted from the character “c”.

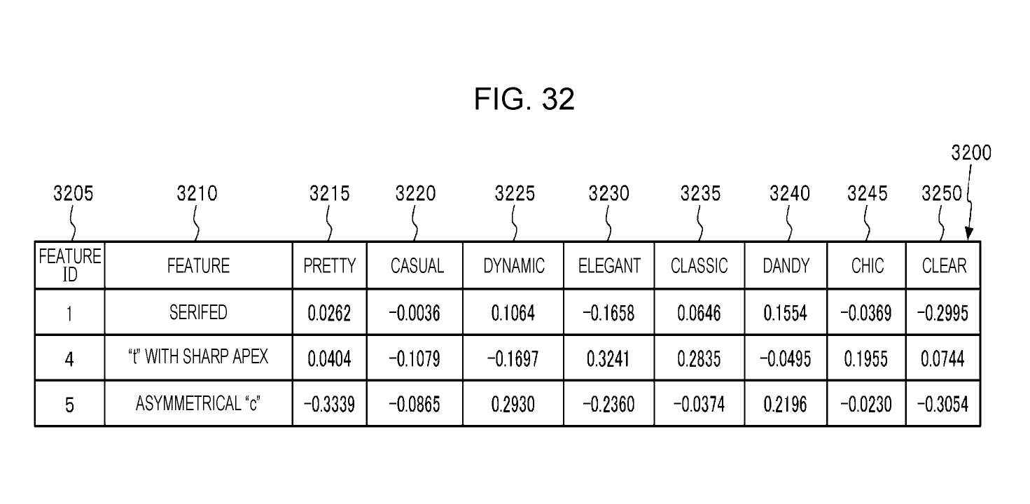

The taste determining module 120 extracts, from the typeface shape feature kansei DB 115, taste points regarding each of the shape features extracted by the character shape analyzing module 110. For example, the taste determining module 120 generates a typeface shape feature kansei table 3200 as the extraction result. FIG. 32 is a diagram illustrating an exemplary data structure of the typeface shape feature kansei table 3200. The typeface shape feature kansei table 3200 includes a feature ID column 3205, a feature column 3210, a pretty column 3215, a casual column 3220, a dynamic column 3225, an elegant column 3230, a classic column 3235, a dandy column 3240, a chic column 3245, and a clear column 3250. This is equivalent to the data structure in the example illustrated in FIG. 12 in the exemplary specific process (1).

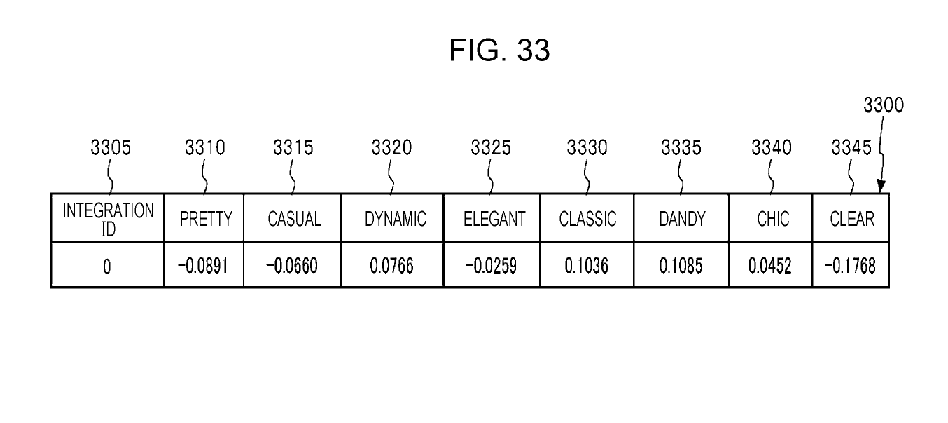

The taste determining module 120 generates a kansei point table 3300 from the typeface shape feature kansei table 3200. FIG. 33 is a diagram illustrating an exemplary data structure of the kansei point table 3300. The kansei point table 3300 includes an integration ID column 3305, a pretty column 3310, a casual column 3315, a dynamic column 3320, an elegant column 3325, a classic column 3330, a dandy column 3335, a chic column 3340, and a clear column 3345. This is equivalent to the data structure in the example illustrated in FIG. 13 in the exemplary specific process (1).

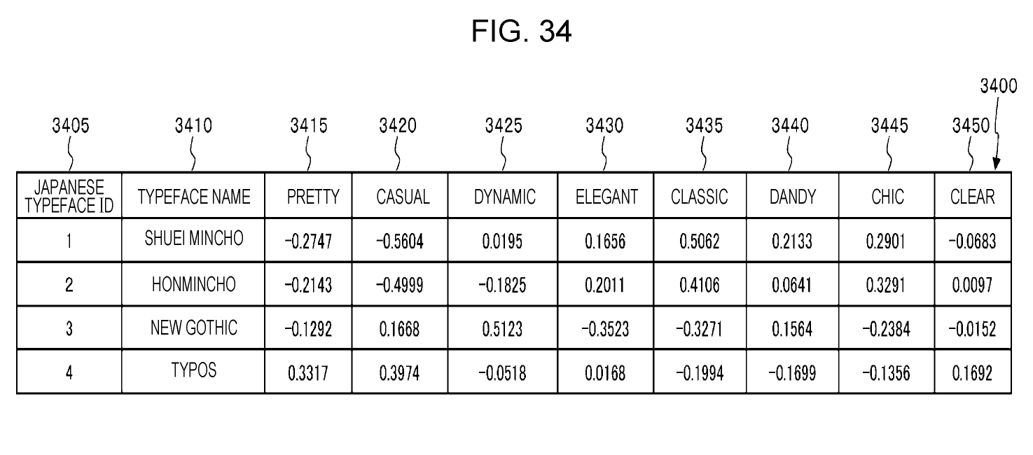

Next, the taste profile comparing module 130 extracts one or more typefaces that are Japanese typefaces and that are usable for the body text from the typeface kansei DB 125. For example, the taste profile comparing module 130 generates a typeface kansei table 3400 as the extraction result. FIG. 34 is a diagram illustrating an exemplary data structure of the typeface kansei table 3400. The typeface kansei table 3400 includes a Japanese typeface ID column 3405, a typeface name column 3410, a pretty column 3415, a casual column 3420, a dynamic column 3425, an elegant column 3430, a classic column 3435, a dandy column 3440, a chic column 3445, and a clear column 3450. This is equivalent to the data structure in the example illustrated in FIG. 14 in the exemplary specific process (1). This is the example where there are four Japanese typefaces (which are types of either “Mincho-tai” (Ming typefaces) or “Gothic-tai” (East Asian gothic typefaces) for the body text.

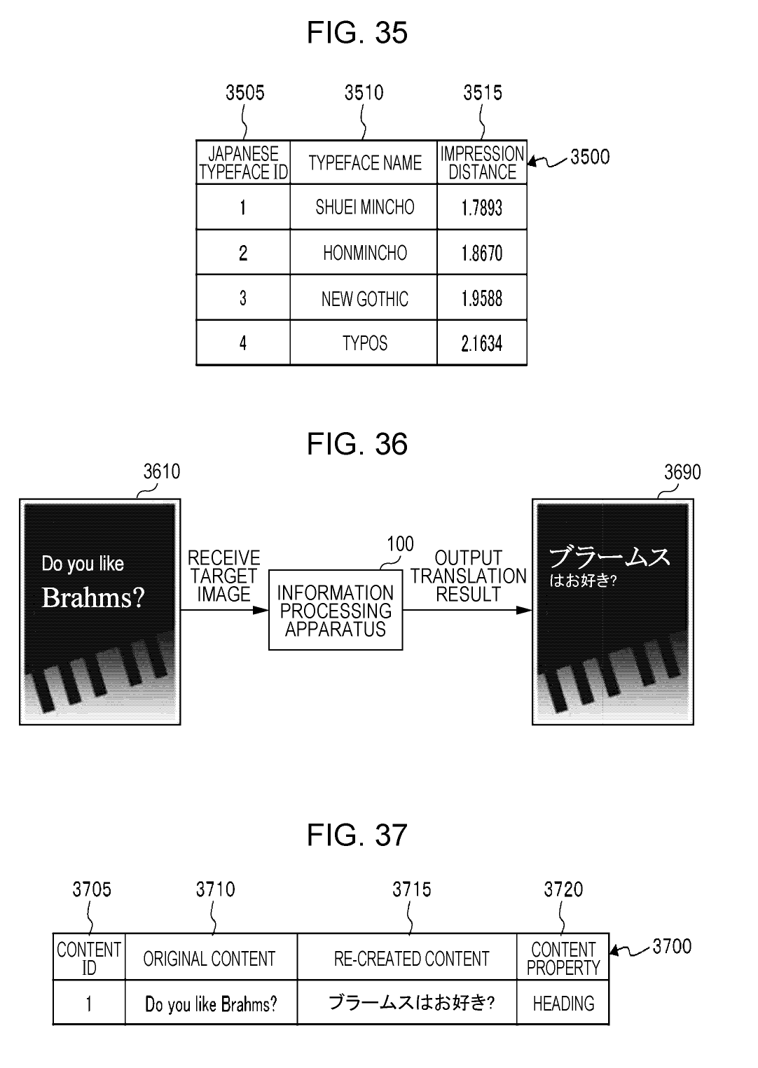

The taste profile comparing module 130 generates an impression distance table 3500 from the kansei point table 3300 and the typeface kansei table 3400. FIG. 35 is a diagram illustrating an exemplary data structure of the impression distance table 3500. The impression distance table 3500 includes a Japanese typeface ID column 3505, a typeface name column 3510, and an impression distance column 3515. This is equivalent to the data structure in the example illustrated in FIG. 15 in the exemplary specific process (1).

Specifically, an impression distance from the integrated kansei points is calculated using the kansei score of each typeface, and, for example, a typeface with the smallest distance (or multiple typefaces including a typeface with the smallest distance) is selected. In this example, the typeface “Shuei Mincho” is selected. For the body text, the result displaying module 135 creates a processing result image 2490 using characters of the typeface “Shuei Mincho” (the body text portions in the re-created content column 2515 in the analysis result table 2500). Obviously, multiple typefaces may be selected, as described above. When multiple typefaces are selected, the body text portions in multiple processing result images 2490 may be created using the individual typefaces.

A processing result image 2490 is generated by combining the previous processing result of the heading portion and this processing result of the body text portions. When multiple typefaces are selected, multiple processing result images 2490 may be created using the individual typefaces, and may be presented to the user 190 to select one from the processing result images 2490.

### Exemplary Specific Process (4)

This is an example in the case where one sentence in a promotional material (paper document or flyer) in English includes multiple typefaces, and this promotional material is translated into Japanese and is re-created as an electronic document using Japanese typefaces stored in the typeface kansei DB 125. In other words, this is the case where the first document is a Latin-script document, and the second document is a Japanese document.

FIG. 36 is a diagram illustrating the exemplary specific process (4) according to the exemplary embodiment. An example will be described in which the information processing apparatus 100 receives a target image 3610 as a target image, and, after the translation, outputs a processing result image 3690 as the re-creation result. Specifically, a flyer in English is scanned, the scanned image is input to the information processing apparatus 100, and a flyer in Japanese with the identical tastes is re-created.

The character shape analyzing module 110 has the function as a character and character-typeface-feature recognition engine and the function as a translation engine, recognizes that the written content of (the language used in) the target image 3610 is English, recognizes the characters, and translates the content from English to Japanese. The character shape analyzing module 110 extracts the shape of each character in the target image 3610. Thereafter, the taste determining module 120 searches the typeface shape feature kansei DB 115 containing Latin typefaces for that shape to obtain taste points, and calculates a taste profile of the characters. The taste profile comparing module 130 has the function as a typeface selecting engine, and picks up (extracts) a Japanese typeface that has tastes similar to the taste profile of the characters, calculated by the taste determining module 120.

An analysis result table 3700 is generated as the processing result of character recognition and translation performed by the character shape analyzing module 110. FIG. 37 is a diagram illustrating an exemplary data structure of the analysis result table 3700. The analysis result table 3700 includes a content ID column 3705, an original content column 3710, a re-created content column 3715, and a content property column 3720. This is equivalent to the data structure of the analysis result table 1000 illustrated in the example in FIG. 10 in the exemplary specific process (1). However, the details in the re-created content column 3715 are in Japanese corresponding to the original content column 3710.

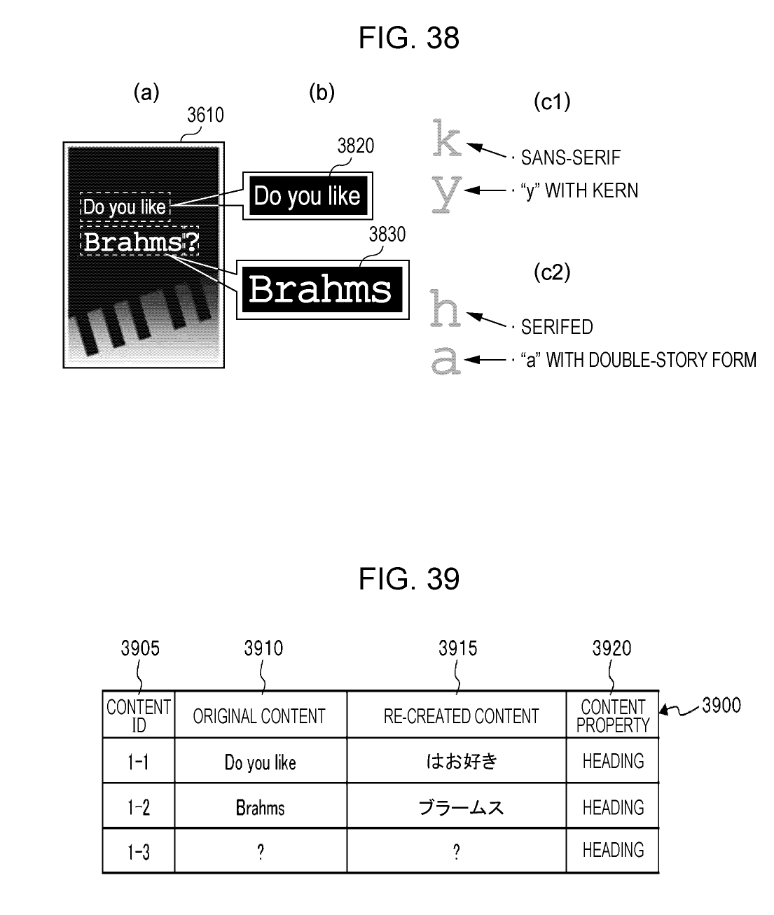

FIG. 38 is a diagram illustrating an exemplary process according to the exemplary embodiment. This indicates an exemplary character shape analyzing process performed by the character shape analyzing module 110.

The character shape analyzing module 110 extracts a heading area 3820 and a heading area 3830 from the target image 3610 (see parts (a) and (b) of FIG. 38). The character shape analyzing module 110 extracts shape features of each of the characters for each typeface. For example, as illustrated in the example in parts (c1) and (c2) of FIG. 38, “sans-serif” is extracted from the character “k”; “‘y’ with kern” is extracted from the character “y”; “serifed” is extracted from the character “h”; and “‘a’ with double-story form” is extracted from the character “a”. Here, there are both “sans-serif” and “serifed”, which contradict each other. The contradicting features are classified into different groups. The term “kern” refers to a round portion of the characters “f”, “j”, “r”, “y”, and the like.

Specifically, the character shape analyzing module 110 separates the analysis result table 3700 for each of the different features to generate an analysis result table 3900. FIG. 39 is a diagram illustrating an exemplary data structure of the analysis result table 3900. The analysis result table 3900 includes a content ID column 3905, an original content column 3910, a re-created content column 3915, and a content property column 3920. This is equivalent to the data structure of the analysis result table 1700 illustrated in the example in FIG. 17. Although all of the characters are headings, they are grouped according to each feature (typeface). Specifically, the characters are grouped into the following three: “Do you like” of typeface A; “Brahms” of typeface B; and “?” of typeface C.

The taste determining module 120 extracts, from the typeface shape feature kansei DB 115, taste points regarding each of the shape features extracted by the character shape analyzing module 110. For example, the taste determining module 120 generates a typeface shape feature kansei table 4000 and a typeface shape feature kansei table 4100 as the extraction results. The typeface shape feature kansei table 4000 corresponds to “Do you like” of typeface A, and the typeface shape feature kansei table 4100 corresponds to “Brahms” of typeface B. For “?”, because “?” is translated as “?”, no typeface change is necessary; thus, the description of the typeface shape feature kansei table 4000 is omitted.

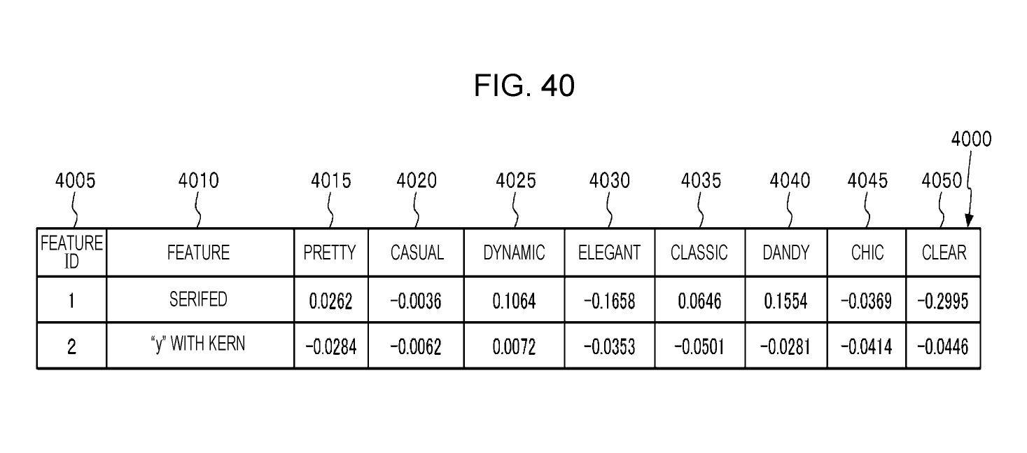

FIG. 40 is a diagram illustrating an exemplary data structure of the typeface shape feature kansei table 4000. The typeface shape feature kansei table 4000 includes a feature ID column 4005, a feature column 4010, a pretty column 4015, a casual column 4020, a dynamic column 4025, an elegant column 4030, a classic column 4035, a dandy column 4040, a chic column 4045, and a clear column 4050. This is equivalent to the data structure in the example illustrated in FIG. 12 in the exemplary specific process (1). The typeface shape feature kansei table 4000 indicates taste points (kansei score) regarding each of features corresponding to Latin typeface A, and includes eight tastes.

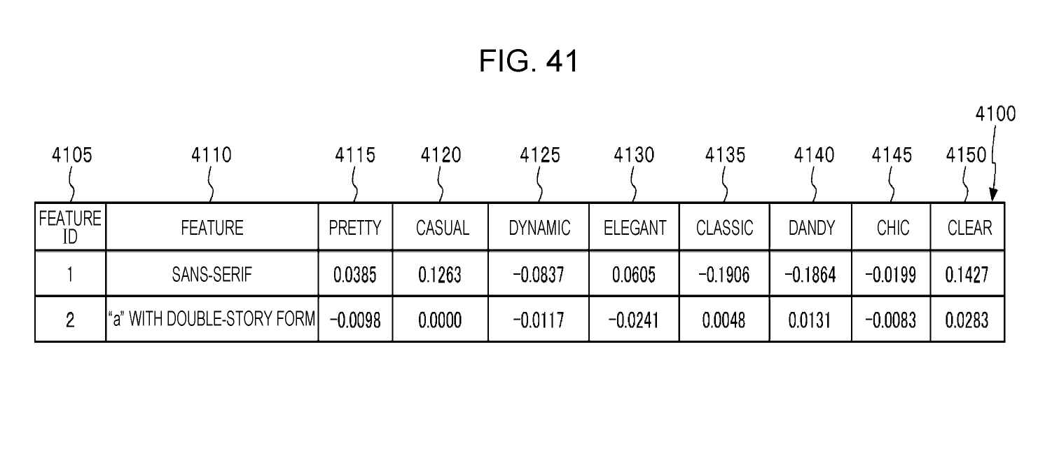

FIG. 41 is a diagram illustrating an exemplary data structure of the typeface shape feature kansei table 4100. The typeface shape feature kansei table 4100 includes a feature ID column 4105, a feature column 4110, a pretty column 4115, a casual column 4120, a dynamic column 4125, an elegant column 4130, a classic column 4135, a dandy column 4140, a chic column 4145, and a clear column 4150. This is equivalent to the data structure in the example illustrated in FIG. 12 in the exemplary specific process (1). The typeface shape feature kansei table 4100 indicates taste points (kansei score) regarding each of features corresponding to Latin typeface B, and includes eight tastes.

Processing thereafter is equivalent to the processing for the heading in the above-described exemplary specific process (3). In other words, taste profiles corresponding to the shape features are integrated for the respective typefaces. In these respective cases, a difference between a taste profile corresponding to each typeface of a specified language (Japanese) and the integrated taste profile is calculated, and a typeface with similar tastes is selected, thereby creating a processing result image 3690.

### Exemplary Specific Process (5)

This is an example in the case where a user interface (UI) menu is translated from a Japanese version to an English version, and is re-created as a UI menu using a Latin typeface stored in the typeface kansei DB 125. In other words, this is the case where the first document is a Japanese document, and the second document is a Latin-script document.

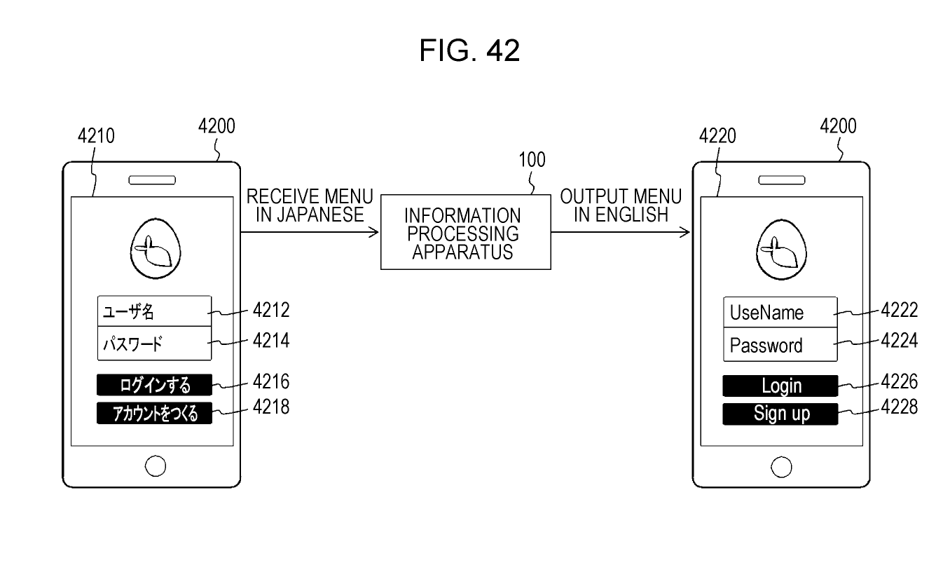

FIG. 42 is a diagram illustrating the exemplary specific process (5) according to the exemplary embodiment. An example will be described in which the information processing apparatus 100 receives data in a Japanese menu screen 4210 as a target document, and, after the translation, outputs an English menu screen 4220 as the re-creation result.

A mobile terminal 4200 is capable of displaying the Japanese menu screen 4210 and the English menu screen 4220. On the Japanese menu screen 4210, a user name column 4212, a password column 4214, a “login” button 4216, and a “sign up” button 4218 are displayed. On the English menu screen 4220, a use name column 4222, a password column 4224, a “login” button 4226, and a “sign up” button 4228 are displayed. The use name column 4222 corresponds to the user name column 4212; the password column 4224 corresponds to the password column 4214; the “login” button 4226 corresponds to the “login” button 4216; and the “sign up” button 4228 corresponds to the “sign up” button 4218. In other words, a Japanese UI menu whose tastes are identical to those of an English UI menu is generated.

The character shape analyzing module 110 has the function as a character-typeface-feature recognition engine and the function as a translation engine, and recognizes that the written content of (the language used in) the Japanese menu screen 4210 is Japanese. The character shape analyzing module 110 extracts, as the shape of characters in the Japanese menu screen 4210, a typeface in accordance with the property. Thereafter, the taste determining module 120 searches the typeface shape feature kansei DB 115 containing Japanese typefaces for that typeface to obtain taste points, and calculates a taste profile of the characters. The taste profile comparing module 130 has the function as a typeface selecting engine, and picks up (extracts) a Latin typeface that has tastes similar to the taste profile of the characters, calculated by the taste determining module 120.

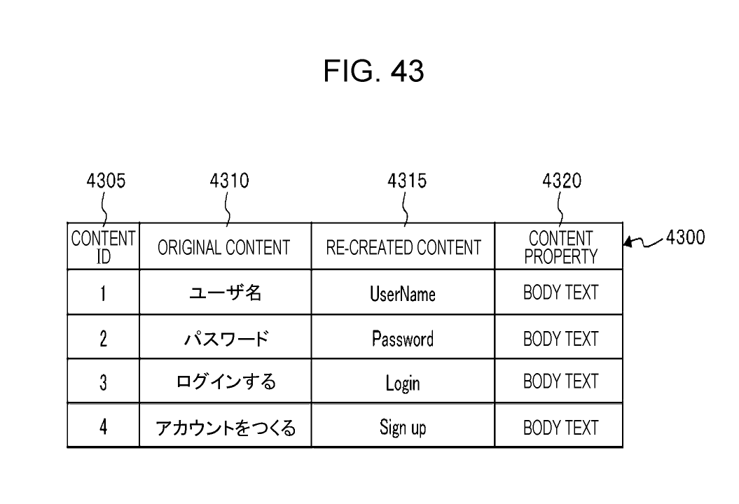

An analysis result table 4300 is generated as the processing result of translation performed by the character shape analyzing module 110. FIG. 43 is a diagram illustrating an exemplary data structure of the analysis result table 4300. The analysis result table 4300 includes a content ID column 4305, an original content column 4310, a re-created content column 4315, and a content property column 4320. This is equivalent to the data structure of the analysis result table 1000 illustrated in the example in FIG. 10 in the exemplary specific process (1).

Processing thereafter is equivalent to the above-described exemplary specific processes.

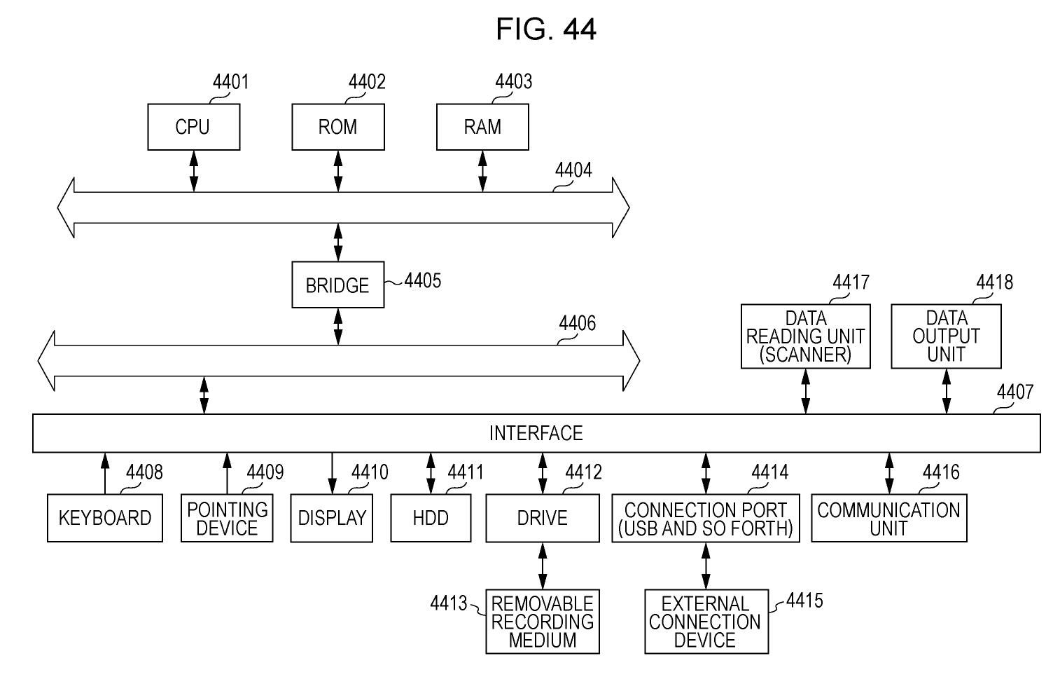

Referring to FIG. 44, an exemplary hardware configuration of an information processing apparatus according to the exemplary embodiment will be described. The configuration illustrated in FIG. 44 is configured by, for example, a personal computer (PC). FIG. 44 illustrates an exemplary hardware configuration including a data reading unit 4417 such as a scanner, and a data output unit 4418 such as a printer.

A central processing unit (CPU) 4401 is a controller that executes processing in accordance with a computer program that describes the execution sequence of each of various modules described in the above-described embodiment, such as the receiving module 105, the character shape analyzing module 110, the taste determining module 120, the taste profile comparing module 130, the result displaying module 135, and the taste adjusting module 240.

Read-only memory (ROM) 4402 stores programs and calculation parameters used by the CPU 4401. Random-access memory (RAM) 4403 stores programs used in execution performed by the CPU 4401, and parameters that arbitrarily change in that execution. These units are connected to one another by a host bus 4404 including a CPU bus or the like.

The host bus 4404 is connected to an external bus 4406 such as a peripheral component interconnect/interface (PCI) bus via a bridge 4405.

A keyboard 4408 and a pointing device 4409 such as a mouse are devices operated by an operator. A display 4410 is, for example, a liquid crystal display (LCD) or a cathode ray tube (CRT), and displays various types of information as text and image information. Moreover, a touchscreen that has both the functions of the pointing device 4409 and the display 4410 may be used.

A hard disk drive (HDD) 4411 includes a hard disk (may be flash memory), drives the hard disk, and records or reproduces programs executed by the CPU 4401 and information. The hard disk realizes the functions as the typeface shape feature kansei DB 115, the typeface kansei DB 125, and the like. Furthermore, the hard disk stores various other types of data, and various computer programs.

A drive 4412 reads data or a program recorded on a removable recording medium 4413 such as a loaded magnetic disk, optical disk, magneto-optical disk, or semiconductor memory, and supplies the data or program to the RAM 4403 connected via an interface 4407, the external bus 4406, the bridge 4405, and the host bus 4404. The removable recording medium 4413 may also be used as a data recording area.

A connection port 4414 is a port for connecting an external connection device 4415, and has a connection part conforming to, for example, Universal Serial Bus (USB) or the Institute of Electrical and Electronics Engineers, Inc. (IEEE) 1394. The connection port 4414 is connected to the CPU 4401 and the like via the interface 4407, the external bus 4406, the bridge 4405, the host bus 4404, and the like. A communication unit 4416 is connected to a communication link and executes data communication with the outside. The data reading unit 4417 is, for example, a scanner, and executes reading of a document. The data output unit 4418 is, for example, a printer, and executes output of document data.

Note that the hardware configuration of the information processing apparatus illustrated in FIG. 44 illustrates one exemplary configuration, and that the exemplary embodiment is not limited to the configuration illustrated in FIG. 44 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link. Furthermore, it may also be configured such that multiple instances of the system illustrated in FIG. 44 are connected to each other by a communication link and operate in conjunction with each other. Additionally, besides a personal computer in particular, an exemplary embodiment may also be incorporated into a device such as a mobile information/communication device (including devices such as a mobile phone, a smartphone, mobile equipment, and a wearable computer), robot, photocopier, fax machine, scanner, printer, or multi-functional peripheral.

Note that the described program may be provided stored in a recording medium, but the program may also be provided via a communication medium. In this case, a “computer-readable recording medium storing a program”, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), the Internet, an intranet, an extranet, or some combination thereof, or alternatively, by being modulated onto a carrier wave and propagated.

Furthermore, the above program may be part or all of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a selector that selects at least one typeface with an impression that is most similar to an impression corresponding to a shape feature of a character extracted from a memory that associatively stores shape features of characters and impressions.

2. The information processing apparatus according to claim 1, wherein:
the impression is configured by a plurality of items, the apparatus further comprising:
an extraction unit that extracts a value of each of the items corresponding to the feature,
wherein the selector selects a typeface in accordance with a distance between the value extracted by the extraction unit and a value of each of the items of the typeface.

3. The information processing apparatus according to claim 2, wherein the extraction unit extracts the value of each of the items corresponding to the feature from a table that associatively contains the feature and the value of each of the items of the impression.

4. The information processing apparatus according to claim 2, further comprising:
an adjustment unit that adjusts the value, extracted by the extraction unit, in accordance with an operation performed by an operator,
wherein the selector selects a typeface in accordance with a distance between the value adjusted by the adjustment unit and the value of each of the items of the typeface.

5. The information processing apparatus according to claim 1, wherein:
the selector extracts the character from a first document, the apparatus further comprising:
a generation unit that generates a second document using a character of the typeface selected by the selector.

6. The information processing apparatus according to claim 5, further comprising:
a translation unit that translates the character in the first document,
wherein the generation unit generates a second document using a translated character of the typeface selected by the selector.

7. The information processing apparatus according to claim 5, wherein:
the first document includes characters of a plurality of typefaces, and
the selector selects a typeface to be used in the second document for each of the typefaces in the first document.

8. The information processing apparatus according to claim 1, further comprising:
a second extraction unit that extracts a shape feature of a character in an image,
wherein the selector performs selection using the feature extracted by the second extraction unit.

9. The information processing apparatus according to claim 1, further comprising:
a third extraction unit that extracts a shape feature of a character in an electronic document,
wherein the selector performs selection using the feature extracted by the third extraction unit.
